(19) United States
(12) Patent Application Publication
(10) Pub. No.: US 2011/0314010 A1
(43) Pub. Date: Dec. 22, 2011

(54) KEYWORD TO QUERY PREDICATE MAPS FOR QUERY TRANSLATION

(75) Inventors: Venkatesh Ganti, Palo Alto, CA (US); Dong Xin, Redmond, WA (US); Yeye He, Madison, WI (US)

(73) Assignee: Microsoft Corporation, Redmond, WA (US)

(21) Appl. No.: 12/817,672

(22) Filed: Jun. 17, 2010

(51) Int. Cl. G06F 17/30

(52) U.S. Cl. 707/728; 707/E17.014; 707/E17.017

(57) ABSTRACT

A query comprising a set of keywords may be applied to a data set having various attributes, but it may be difficult to determine the query predicates intended for each keyword (e.g., the attributes targeted by each keyword, and the values of those attributes satisfying the keyword.) The meaning of a keyword of interest may be inferred from a set of query pairs, comprising a background query (comprising a set of keywords excluding the keyword of interest) and a foreground query (comprising the same set of keywords but also including the keyword of interest.) Differences in the query results for the foreground query and the background query of many query pairs may identify a query predicate intended by the keyword and a confidence score. These results may be associated with the keyword in a keyword map, useful for translating queries into query predicates that may yield relevant query results.

### BACKGROUND

Within the field of computing, many scenarios involve an application of a query to a data set comprising a set of data entries, such that the data entries matching the selectivity criteria of the query are identified and returned as a set of query results. The query often comprises a set of keywords, which may be structured in many ways (e.g., as a natural-language query, a Boolean query having several criteria organized in a logical framework, or a specific phrase with which matching query entries are associated.) The query may also be generated by and received from many types of sources, including a user who may enter the query as text into a textbox control of a website or application and an automated process that may request, receive, and utilize data entries matching certain criteria.

In some scenarios, the data set may comprise a set of structured data, such as a database comprising a set of records, an extensible markup language (XML) document specifying a set of entities in a well-structured declarative format, and an object library comprising a set of objects having particular properties. In regard to such structured data sets, a query may specify criteria to be applied against one or more attributes of the data set (e.g., one or more attributes of a database table, one or more attributes of the entities of an XML document, or one or more member fields or properties of an object.) For example, in a data set representing people, a query may specify criteria such as “people having the first name of ‘David’, a last name beginning with the letter ‘S’, and an age between 15 and 45 years.” The various attributes specified in this query may be applied against corresponding attributes of the data set (e.g., the first name, last name, and age fields, respectively) in order to identify people who match the specified criteria.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Several difficulties may arise when applying a query against a well-structured data set having various attributes. As a first example, the query may not specify an attribute against which a particular field is to be applied; e.g., a data set representing people may be targeted by a query specifying the query term “Louis,” but it may not be clear whether this query term refers to a first name, a last name, or a resident of the city of St. Louis in the state of Missouri in the United States. As a second example, the query may be intended to seek data entries of a particular type, but may include terms that do not precisely describe the particular type; e.g., a data set comprising data entries that represent a set of computers may be targeted by a query specifying “portable” computers, but this term may be validly interpreted in many ways (e.g., workstations that may be easily transported, such as featuring a case with a handle; workstations having integrated components, such as an all-in-one computer built into a display; computers having a comparatively mobile architecture, such as a notebook, netbook, tablet, or palmtop; computers having components that facilitate travel, such as an integrated battery and a wireless or cellular network adapter; notebook computers having comparatively small dimensions and that may fit into small compartments; or lightweight computers that are easily hefted.) Because of the unstructured and possibly ambiguous nature of such queries, it may be difficult to provide query results that meet the intent of the query.

Techniques may be utilized to identify intended meanings of the terms of a query. In particular, techniques may be identified to determine, for a particular query term such as a keyword, the data entries that the query term differentially selects (and excludes) in contrast with queries that do not include the query term. For example, from a historic set of queries received and applied to the data set, a set of query pairs may be identified, where each query pair comprises a “background query” comprising a set of background query terms, and a “foreground query” comprising the set of background query terms along with a foreground keyword. The data entries of the data set that are more often selected when the foreground keyword is included may be identified as potentially relevant to the foreground keyword. Among many such sets of data entries for many query pairs, a shared property in a particular attribute of the differentially selected query results may be identified, and a query predicate may be identified that targets the shared property in the attribute. This query predicate may be associated with the keyword in a keyword map, along with a confidence score (e.g., an estimate of the confidence that the query predicate selects data entries consistently with the intent of the query designer.) In this manner, the prevalent selectivity of a particular keyword over the data entries of the data set may be identified.

The keyword map prepared in this manner may be utilized in the application of search queries to the data set in order to identify query results that have higher relevance to the intent of the search query. For example, when a query is received, the keywords of the query may be translated into the query predicates respectively associated with the keywords according to the keyword map. The translated query may be applied to the data set (with particular query predicates selectively restricting corresponding attributes of the data set), thereby improving the relevance of the query results to the query designer based on inferences about the predicted meanings of the keywords of the query. As another technique, the query may be interpreted as a set of tokens, where the tokens may be partitioned in different ways to achieve different sets keywords (e.g., “small business notebook” may be partitioned into the keywords “small” and “business notebook,” or into the keywords “small business” and “notebook”.) In order to choose among the different keyword sets that may be partitioned from the query, the confidence scores of the various keywords of each keyword set may be aggregated, and the keyword set having a high confidence score, which may represent a high correlation between the selected keyword set and the intended meaning of the query, may be selected.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring an application of various queries comprising keywords to a data set.

FIG. 2 is an illustration of an exemplary scenario featuring an identification of query pairs of a particular keyword applied to a data set according to the techniques presented herein.

FIG. 3 is an illustration of an exemplary scenario featuring a generation of a keyword map using query pairs identified for a keyword according to the techniques presented herein.

FIG. 4 is an illustration of an exemplary scenario featuring an exemplary use of a keyword map to translate a query into a translated query according to the techniques presented herein.

FIG. 5 is an illustration of an exemplary scenario featuring another exemplary use of a keyword map to translate a query into a translated query according to the techniques presented herein.

FIG. 6 is a flow chart illustrating an exemplary method of generating a keyword map associating respective keywords with a query predicate.

FIG. 7 is a flow chart illustrating an exemplary method of applying a query comprising at least one token to a data set.

FIG. 8 is an illustration of an exemplary computer-readable medium comprising processor-executable instructions configured to embody one or more of the provisions set forth herein.

FIG. 9 is an illustration of an exemplary scenario featuring an evaluation of a keyword utilizing a dictionary.

FIG. 10 is an illustration of an exemplary scenario featuring an evaluation of various keywords using various keyword evaluators.

FIG. 11 is an illustration of an algorithm for evaluating a keyword using various keyword evaluators.

FIG. 12 is an illustration of an algorithm for partitioning tokens of a query into keywords.

FIG. 13 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve the application of a search query to a data set comprising various data entries having a particular structure. As a first example, a relational database comprises one or more related tables, where each table comprises a particular set of fields that confer structure upon records stored in the table, and an SQL query may be applied to the relational database to select records or combinations thereof based on criteria to be applied to the fields of specified tables. As a second example, an object database comprises a set of objects having various fields, and an object query may be applied to the object database to identify objects having fields that match various criteria of the object query.

In many such scenarios, the query may be specified as a set of keywords, which may be matched to the values of various attributes for various data entries of the data set. For example, a natural language search engine may interface with a data set comprising a set of data entries having natural language fields (e.g., a database of news articles comprising a title, a location, a date, an abstract, an author name, and the body of the news article), may accept a natural language query crafted by a user as a set of keywords, and may apply the keywords of the natural language query to the fields of the news article database to identify matching news articles that may be returned as search results. In such scenarios, it may be difficult to identify how the keywords of the search query are to be applied to the various attributes of the data set; e.g., a search query specifying the keyword “Louis” may apply to an article on the topic of a hurricane named Louis, or to an article written by a reporter named Louis, or to articles relating news arising in the location of the city of St. Louis, Mo. Therefore, interpreting the meaning of the query that may have been intended by the user may significantly impact the relevance of the search results to the user, and techniques for improving the identification of such intent may yield search results with improved relevance and value to the user.

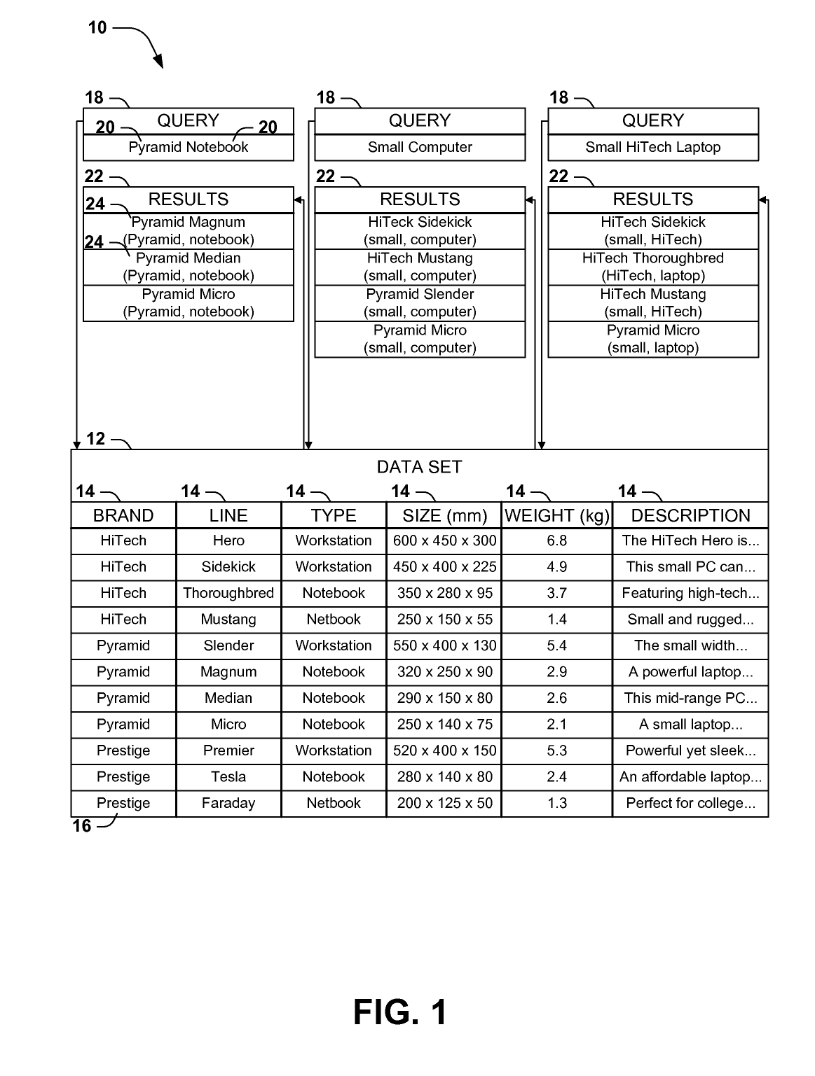

FIG. 1 presents an exemplary scenario 10 featuring the application of a data set 12 having a set of attributes 14, and a set of data entries 16 having a particular value for each attribute 14 in the data set 12. In this exemplary scenario 10, the data set 12 comprises a database of computers (e.g., an inventory of computers owned by an entity such as a university, or a set of products offered by an e-commerce site), where each data entry 16 identifies a particular computer and features values for respective attributes 14 such as the brand name of the manufacturer, the product line of the computer offered by the manufacturer, the type of computer (such as a workstation, a notebook, or a netbook), the size and weight of the computer, and a plaintext description of the computer (such as a textual advertisement.) This data set 12 may be subjected to various queries 18, each requesting a list of data entries 16 that match a set of keywords 20, such as “Pyramid notebook,” “small computer,” and “small HiTech laptop.” The data set 12 may utilize various search techniques to identify the data entries 16 matching each query 18, and may return the identified data entries 16 as a result set 22 comprising query results 24 matching the keywords 20 of the query 18. A simple application of the query 18 might involve searching all attributes 14 of the data set 12 for each keyword 20, and identifying every search entry 16 having each keyword 20 in at least one attribute 14. For example, in identifying query results 24 for the first query 18, the data set 12 might evaluate each data entry 16 to identify those that include the keyword 20 “Pyramid” in at least one attribute 14, and that also include the keyword 20 “notebook” in at least one attribute 14.

While many ways of applying the keywords 20 of the query 18 to the data set 12 may be utilized, it may be appreciated that more sophisticated techniques may be capable of selecting search results that are of greater value to the user who submitted the query. In particular, some techniques may be able to identify the semantics of the query 18 with improved accuracy, such as the intended meanings of the various keywords 20 in relation to the data set 12, and may be able to identify search entries 16 that are more directly relevant to the semantic intent of the query. These techniques may be particularly helpful for satisfying natural language queries, where keywords may have different intended meanings in different contexts. For example, in the exemplary scenario 10 of FIG. 1, the first query 18 may present keywords with a comparatively unambiguous meaning, e.g., requesting a list of all notebook computers having the manufacturer brand “Pyramid,” and the qualifying query results 24 may be identified with a high degree of confidence through a cursory examination of the data set 12. However, the second query 18, specifying a “small computer,” may be more ambiguous and more difficult to interpret. For example, the term “small” likely refers to the size of the computer, but this determination may have different meanings in different aspects; e.g., a comparatively “small” workstation computer may have different dimensions than a comparatively “small” notebook computer. Indeed, a comparatively “small” workstation computer may have greater dimensions and weight than a comparatively “large” notebook computer. Additionally, it might be difficult to apply the keyword “computer,” as an automated process might endeavor to apply the term “computer” to the “Description” attribute 14 of the data set 12, but this keyword 20 might arbitrarily be included in some of the descriptions (e.g., “this computer is capable of . . . ”) and might arbitrarily be absent from other descriptions (e.g., “this notebook is capable of . . . ”), thereby causing an arbitrary filtering of the result set 18.

The third query 18 in the exemplary scenario 10 of FIG. 1, comprising the keywords 20 “small HiTech laptop,” may be even more difficult to evaluate in an automated manner, as it may not be clear how to interpret the term “small” in view of the terms “HiTech” and “laptop.” For example, the term “small” might specify “small” computers as compared with other HiTech computers, or might specify “small” computers within other notebook computers. It might also be difficult to identify that “laptop” is a common synonym for the term “notebook,” as used in the “Type” attribute 14. This distinction may lead to different result sets 22; e.g., if all HiTech notebook computers are smaller than the average notebook computer, then it may not be clear whether the user is simply requesting any HiTech notebook, or a notebook computer that is comparatively small by HiTech standards. Additionally, the terms “small,” “HiTech,” and “laptop” might be automatically applied to different attributes 14, such as the “Description” attribute 14. The result set 22 might therefore include a computer of a non-HiTech brand that coincidentally includes the following phrase in the Description attribute 14: “As small as a HiTech laptop, this computer . . . .” In these and other scenarios, it may be difficult to identify the semantic meaning of various keywords 20 of the query 18, and therefore to produce a result set 22 comprising query results 24 that are of high relevance to the author of the query 18.

In these and other scenarios, it may be difficult to apply the query 18 to the data set 12 in a manner that produces a result set 22 of high relevance to the author of the query 18 because it may be unclear how to translate the keywords 20 of the query 18 into the selectivity criteria of the query 18. For example, it may be difficult to select one or more attributes 14 of the data set 12 that are targeted by the keyword 20, or how to evaluate the values of such attributes 14 of various data entries 16 for the keyword 20 (e.g., the qualifying dimensions of a “small” computer.) Additionally, it may be difficult to interpret semantic relationships among keywords 20 of the query 18, e.g., how to interpret the keyword “small” in view of the additional keywords “HiTech” and “laptop.” While it may be possible to identify the semantic intent of such queries 18 in a non-automated way (e.g., by having other users identify the likely semantic intent of various queries 20, such as in a “mechanical Turk” solution, or by having users define query predicates for various search terms), such techniques may be inaccurate, cumbersome, or inefficient.

Alternative techniques for evaluating queries 18 may be devised that may be capable of producing query results 24 of a comparatively high relevance to the author of the query by identifying with improved confidence the intent of respective keywords 20 of the query 18, both in isolation and in the context of the other keywords 20 of the query 18. It may be appreciated that many queries 18 may have been issued against a data set 12, and may be recorded, e.g., in a query set, such as a historic log of queries 18 that have been formulated and applied to the data set 12. An evaluation of these queries 18, and the result sets 22 generated thereby, may reflect some semantic details about the interpretations of keywords 20 that are often included in such queries 18, both in isolation and in the context of other keywords 20 utilized in the same query 18. For example, a query 18 containing the keywords “small computer” may yield a comparatively arbitrary result set 22 if the semantic intent of the keyword 20 “small” cannot be easily determined. However, the result sets 22 of other queries 18 featuring the keyword 20 “small,” such as queries 18 for “small netbook,” “small workstation,” and “small notebook” may yield result sets 22 that confer a fairly specific and consistent meaning upon the keyword “small”—especially if such result sets 22 are compared with the result sets 22 of corresponding queries 18 that omit the keyword, such as queries 18 for “netbook,” “workstation,” and “notebook.” That is, by comparing the result sets 22 of corresponding pairs of queries 18, such as “small netbook” and “netbook,” “small workstation” and “workstation,” and “small notebook” and “notebook,” an automated process may identify a consistent semantic meaning attributed to each instance of the keyword 20 “small” as indicating computers with comparatively low numbers in the “size” attribute. This identification may be utilized both generally, e.g., to determine what the keyword 20 “small” may connote in other queries (such as “small computer”), and also specifically, e.g., to determine what the keyword 20 “small” may connote in the specific queries 18 so formulated (such as the dimensions that constitute a “small” notebook, vs. the dimensions that constitute a “small” workstation.) These identified semantics of the keyword 20 “small” may therefore be applied in the evaluation of other queries. 18. For example, if the keyword 20 “small” is later used in a new context, such as “small server,” the prior evaluations of the keyword 20 “small” in other contexts may suggest a comparison of the dimensions of various computers qualifying as servers and the subset of such computers that have low values in the “size” attribute 14. In this manner, the process of interpreting the intended semantics of various keywords 20 that may be encountered in various queries 18 may be automated, and the resulting determinations may be used to apply such keywords 20 to the attributes 14 of the data set 12 in a manner that produces result sets 22 that are highly relevant to the intent of such queries 18.

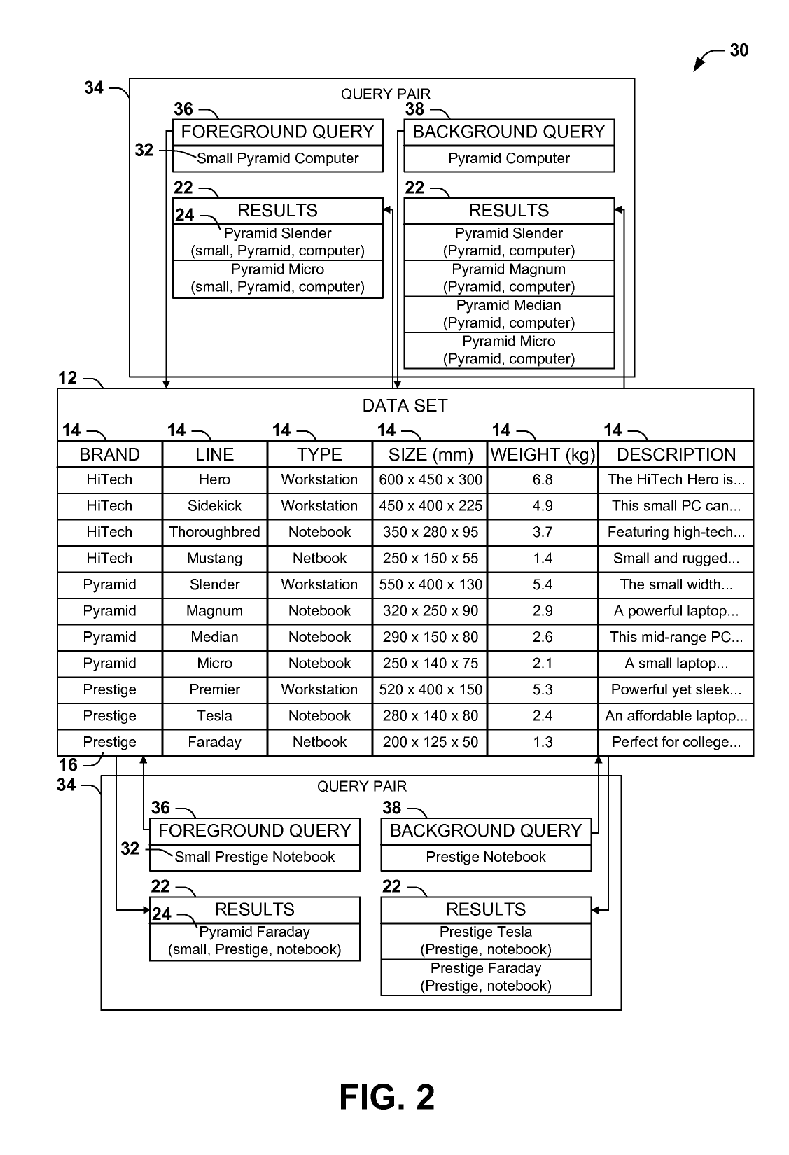

FIGS. 2-5 present exemplary scenarios that together illustrate some exemplary uses of these techniques. FIG. 2 presents an exemplary scenario 30 featuring the same data set 12 as presented in FIG. 1, having the same data entries 16 that represent a set of computers according to various attributes 14. In this exemplary scenario 30, the semantic meaning of the keyword 32 “small” is identified by comparing the result sets 22 of various query pairs 34. With regard to a particular keyword 32, a query pair 34 comprises a pair of queries that may illustrate the semantic meaning of the keyword 32—specifically, a background query 38 that includes some other keywords 20 (such as “Pyramid computer” or “Prestige notebook”) but omits the keyword 32 of interest, and a foreground query 38 that includes both the other keywords 20 and the keyword 32 of interest (such as “small Pyramid computer” or “small Prestige notebook”.) For each query pair 34, the result sets 22 of both queries 18 may be retrieved, and may be evaluated to identify a consistent difference among the query results 24 comprising the result set 22 of the foreground query 36 as compared with the query results 24 comprising the result set 22 of the background query 38. For example, in a first query pair 34, the query results 24 retrieved for a “small Pyramid computer” query 18 (as the foreground query 36) may be compared with the query results 24 retrieved for a “Pyramid computer” query 18 (as the background query 38), and it may be identified that the foreground query 36 suggests an additional selectivity criterion indicating smaller values in the “size” attribute 14 as compared with other computers of the same type (i.e., dimensions that include the “Pyramid Micro” and “Pyramid Slender” computers, but that exclude the “Pyramid Median” and “Pyramid Magnum” computers of the same types but larger dimensions.) Additionally, in a second query pair 34, the query results 24 retrieved for a “small Prestige computer” query 18 (as the foreground query 36) may be compared with the query results 24 retrieved for a “Prestige computer” query 18 (as the background query 38), and it may be identified that the foreground query 36 suggests an additional selectivity criterion indicating values in the “size” attribute 14 below 280×140×80 millimeters (i.e., dimensions that include the “Prestige Faraday” computer but that exclude the “Prestige Tesla” computer.)

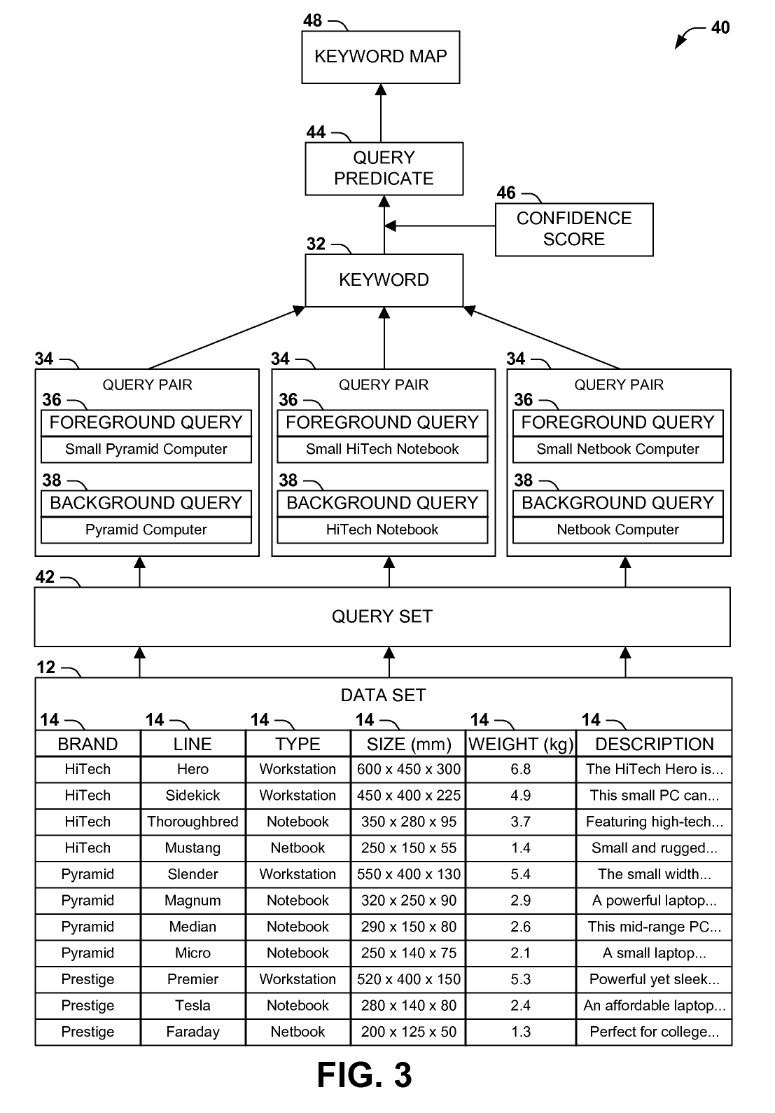

If many query pairs 34 are evaluated for a keyword 32 of interest, it may be possible to identify a particular semantic interpretation of the keyword 32 as a query predicate 44 that applies the inferred selectivity criteria to the data set 12, as well as an indication of the consistency of this inference. FIG. 3 presents an exemplary scenario 40 wherein a query set 42 may be mined to identify several query pairs 34 that have previously been formulated for the keyword 32 “small,” such as a first query pair 34 comprising the foreground query 36 “small Pyramid computer” and the background query 38 “Pyramid computer,” a second query pair 34 comprising the foreground query 36 “small HiTech notebook” and the background query 38 “HiTech notebook,” and a third query pair 34 comprising the foreground query 36 “small netbook computer” and the corresponding background query 38 “netbook computer.” For these query pairs 34, the result sets 22 the queries 18 may be compared to identify a selectivity criterion associated with the keyword 32, such as a consistent selectivity criterion that the term “small” usually leads to query results 24 having low values in the “size” attribute 14. Of course, other interpretations may also be possible (e.g., computers having comparatively low weights, or computers of the “notebook” or “netbook” types as opposed to computers of the “workstation” type), but such selectivity criteria may be less consistent across all query pairs 34 for the same keyword 32 of interest. Based on this inference, a query predicate 44 may be formulated for the keyword 32 that captures the selectivity criterion identified from the query pairs 34. Moreover, a confidence score 46 may be computed as an indication of the consistency of this selectivity criterion across all such query pairs 34. (For example, the confidence score 46 for the selectivity criterion corresponding to low values in the “size” attribute 14 may be higher than the confidence scores for selectivity criteria corresponding to low values in the “weight” attribute 14 or based on the “type” attribute 14, each of which may produce lower confidence scores 46.) The selected query predicate 44 and confidence score 46 may then be stored in a keyword map 48 in association with the keyword 32, which may be utilized in order to apply the evaluated keywords 32 in subsequently received queries 18.

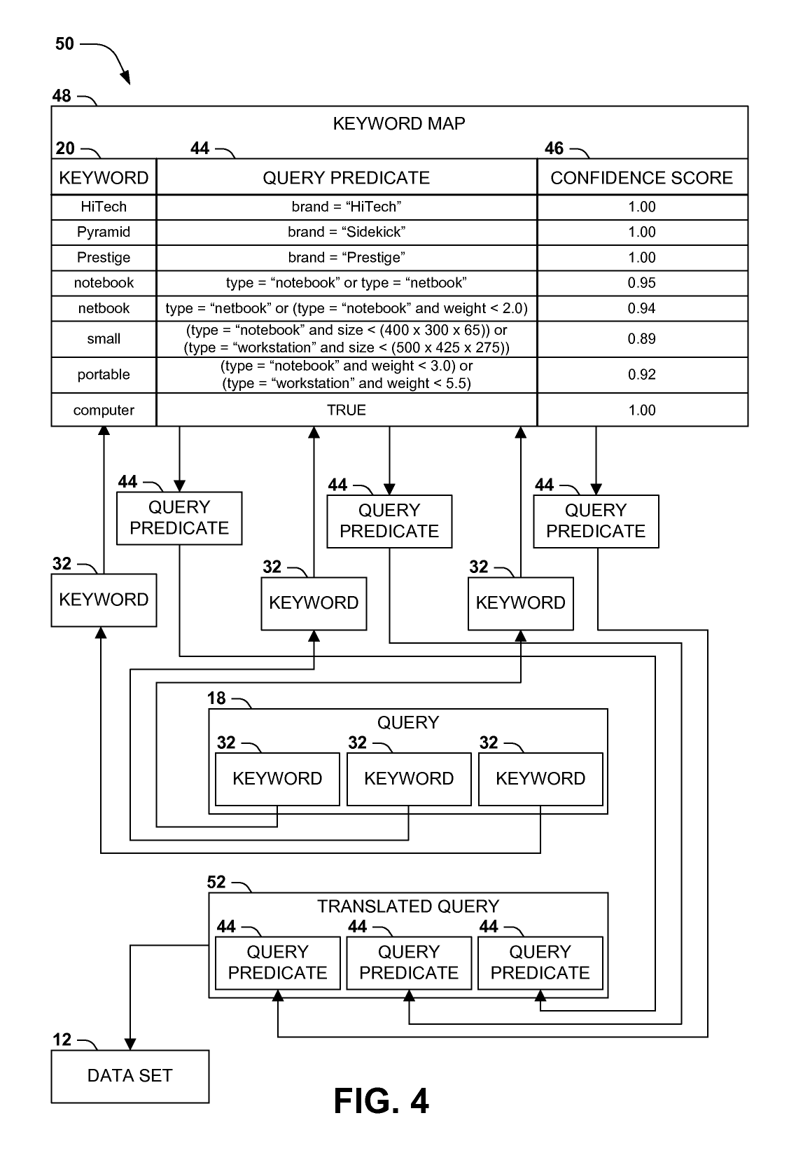

FIG. 4 presents an illustration of an exemplary scenario 50 featuring one use of a keyword map 48, prepared as illustrated in FIGS. 2-3, to apply a query 18 to the data set 12. The query 18 may be received as a phrase, such as “small HiTech notebook,” and may be partitioned into a series of keywords 32, such as “small,” “HiTech,” and “notebook.” For each keyword 32, the keyword map 48 may be consulted to retrieve an associated query predicate 44 and confidence score 46. The query predicates 44 may then be aggregated into a translated query 52, which may be applied to the data set 12. As one example, respective keywords 32 may be associated in the keyword map 48 with various fragments a Structured Query Language (SQL) query; e.g., the keyword 20 “HiTech” may be associated with the fragment “brand=‘HiTech’”, the keyword 20 “portable” may be associated with the fragment “weight <7.0”, and the keyword 20 “notebook” may be associated with the fragment “type=‘Notebook’ or type=‘Netbook’”. Accordingly, when a natural language query 18 such as “portable HiTech notebook” is received, the query predicates 44 corresponding to each keyword 20 may retrieved and aggregated into a SQL query, such as “select * from Computers where (weight <7.0) and (brand=‘HiTech’) and (type=‘Notebook’ or type=‘Netbook’);” This translated query 52 may be directly applied to the data set 12 to retrieve data entries 16 that reflect the intent of the natural language query. Moreover, the confidence scores 46 of the query predicates 44 may be retrieved as a measure of the confidence that the query predicates 44 reflect the inferred intent of the query 18.

While the exemplary scenario 50 of FIG. 4 reflects one exemplary technique for translating the query 18 into a translated query 52, other techniques may present additional advantages. However, this technique presumes that the query 18 may be unambiguously partitioned into keywords 20, such as by parsing a string based on whitespace characters into tokens that correspond to individual keywords 20. However, in some scenarios, this parsing may present an additional difficulty if some keywords comprise multiple tokens; e.g., the brand name “HiTech” might instead be spelled as “Hi Tech,” which might be partitioned into two tokens but might be intended as one keyword 20. Additionally, some tokens might comprise different keywords 20 based on other tokens. For example, the token “large” might be have different semantic identifiers when included in the queries “large notebook,” “large display notebook,” and “large keyboard notebook,” and this intent may only be identifiable by examining the other tokens in the query 18. Therefore, other techniques may be utilized to partition the query 18 into keywords 20, and the keyword map 48 may be utilized in this endeavor. In particular, the tokens of the query 18 may be combined into various sets of keywords 20 that are represented in the keyword map 48, and a set of keywords 20 that together having a high confidence score 46 (as compared with the confidence scores of the keywords 20 of other keyword sets) may be selected as likely matching the intent of the author of the query 18.

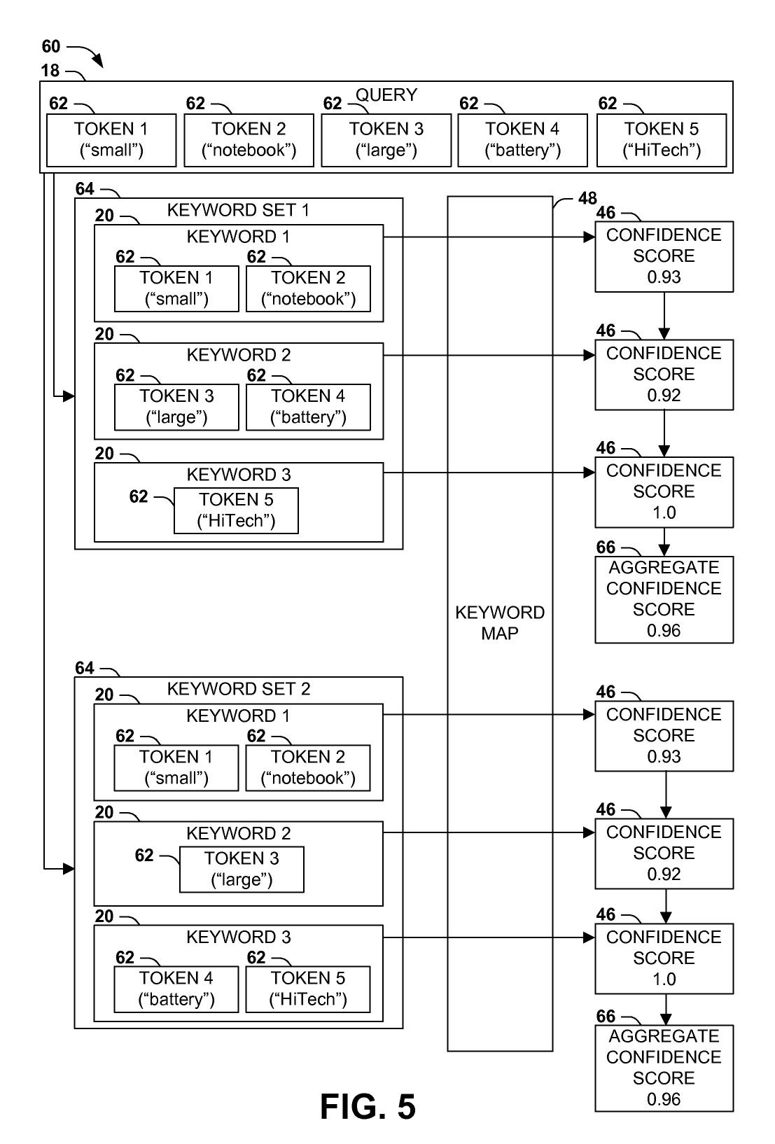

FIG. 5 presents an exemplary illustration 60 of an exemplary application of this technique for generating the translated query 52 from a query 18 comprising a set of tokens 62. The query 18 may comprise, e.g., a set of natural language terms separated by whitespace or punctuation characters, which may be partitioned into tokens that are to be grouped into keywords 20. In this exemplary scenario 60, the query 18 comprises the phrase “small notebook large battery HiTech.” A less sophisticated translation of the query 18 into a translated query 52, such as the technique illustrated in the exemplary scenario 50 of FIG. 4, may encounter difficulties reconciling the query predicates 44 selected for the keywords 20 of this query 18, since the keywords 20 “small” and “large” are both included but typically have opposing meanings. However, a more sophisticated technique may identify a proper grouping of the tokens 62 into keywords 20 that reflect the intent of the author of the query 18. In the exemplary scenario 60 of FIG. 5, various keyword sets 62 are assembled, wherein the tokens 62 of the query 18 are grouped into a distinctive set of keywords 20. For example, a first keyword set 64 may group the tokens 62 “small” and “notebook” into a first keyword 20, the tokens 62 “large” and “battery” into a second keyword 20, and the remaining token 62 “HiTech” into a third keyword 20; while a second keyword set 64 may group the tokens 62 “small” and “notebook” into a first keyword 20, the token 62 “large” into a second keyword 20, and the remaining tokens 62 “battery” and “HiTech” into a third keyword 20. Other keyword sets 64 may also be assembled and tested. For each keyword set 64, the keyword map 48 may be consulted to retrieve the query predicates 44 and confidence scores 46 associated with each keyword 20. Moreover, the confidence scores 46 may be aggregated (such as through addition, max, min, arithmetic mean, arithmetic median, or arithmetic mode computations) to compute an aggregated token confidence score 66 for each keyword set 64. A keyword set 64 having a high aggregate confidence score 66 may be selected as having a high probability of reflecting the intent of the author of the query 18. For example, each keyword 20 of the first keyword set 64 may be associated with a high confidence score 46 in the keyword map 48, leading to a high aggregate confidence score 66, while the second keyword set 64 may present lower confidence scores 46 for the keywords 20 “large” (which may have a more ambiguous meaning) and “battery HiTech” (which may not have an identified meaning as a keyword 20.) In this manner, various combinations of tokens 62 may be evaluated as different keyword sets 64, and the keyword set 64 having a desirably high confidence (as measured by the aggregate confidence score 66) may be selected for translation into the translated query 52 and application to the data set 12.

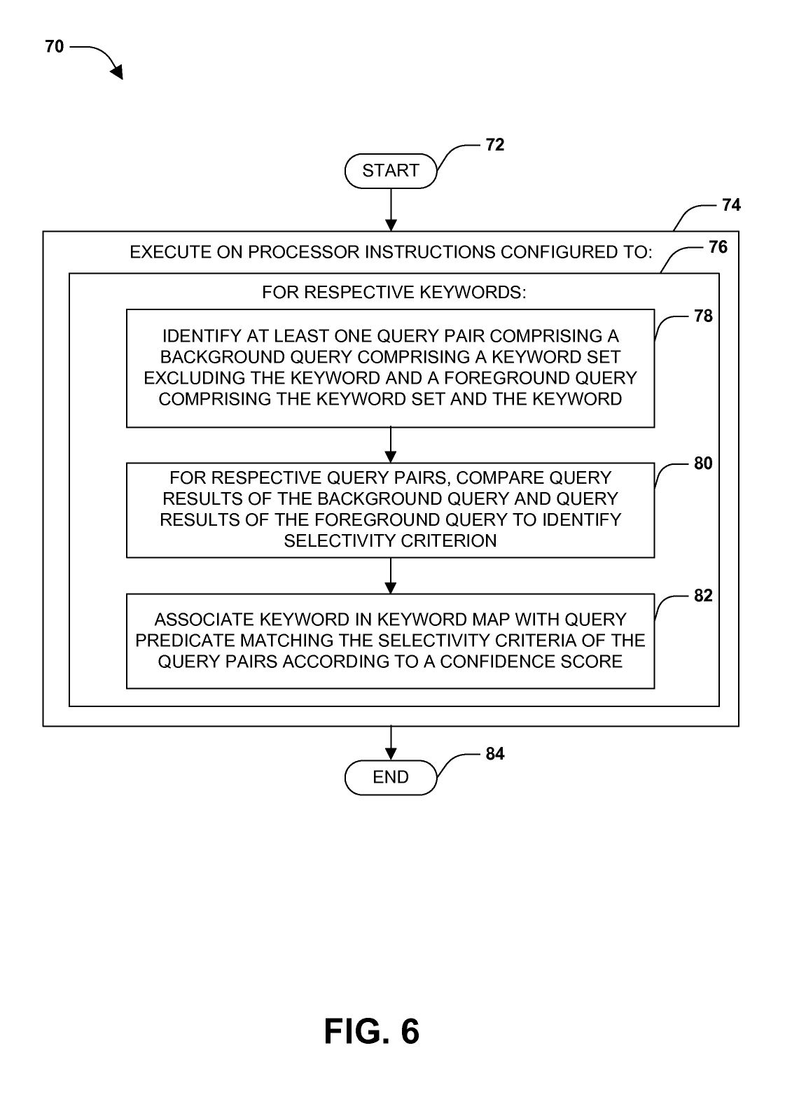

FIG. 6 presents a first exemplary embodiment of the techniques presented herein, illustrated as an exemplary method 70 of generating a keyword map 48 associating respective keywords 20 with a query predicate 44. The exemplary method 70 may be performed on a device having a processor, which comprises at least one query 18 comprising at least one keyword 32 and at least one query result 24 selected from the data set 12 according to the query 18. The exemplary method 70 begins at 72 and involves executing 74 on the processor instructions configured to perform the techniques presented herein to generate the keyword map 48 (such as according to the exemplary scenarios of FIGS. 2-3.) In particular, the instructions are configured to, for respective keywords 76, identify 78 at least one query pair 34 comprising a background query 38 comprising a keyword set excluding the keyword 20 and a foreground query 36 comprising the keyword set and the keyword 20. The instructions are also configured to, for respective keywords 74 and for respective query pairs 34, compare 80 the query results 24 of the background query 38 and the query results 24 of the foreground query 36 to identify a selectivity criterion. Finally, the instructions are configured to, for respective keywords 74, associate 82 the keyword 20 in the keyword map 48 with a query predicate 44 matching the selectivity criteria of the query pairs 34 according to a confidence score 46. In this manner, the keyword map 48 may be generated through the evaluation of query pairs 34 for respective keywords 20, and the keyword map 48 may then be utilized to facilitate the translation of queries 18 into translated queries 52 that more accurately reflect the intent of the author of the query 18 (such as in the exemplary scenario 50 of FIG. 4. Having achieved the generation of the keyword map 48, the exemplary method 70 ends at 84.

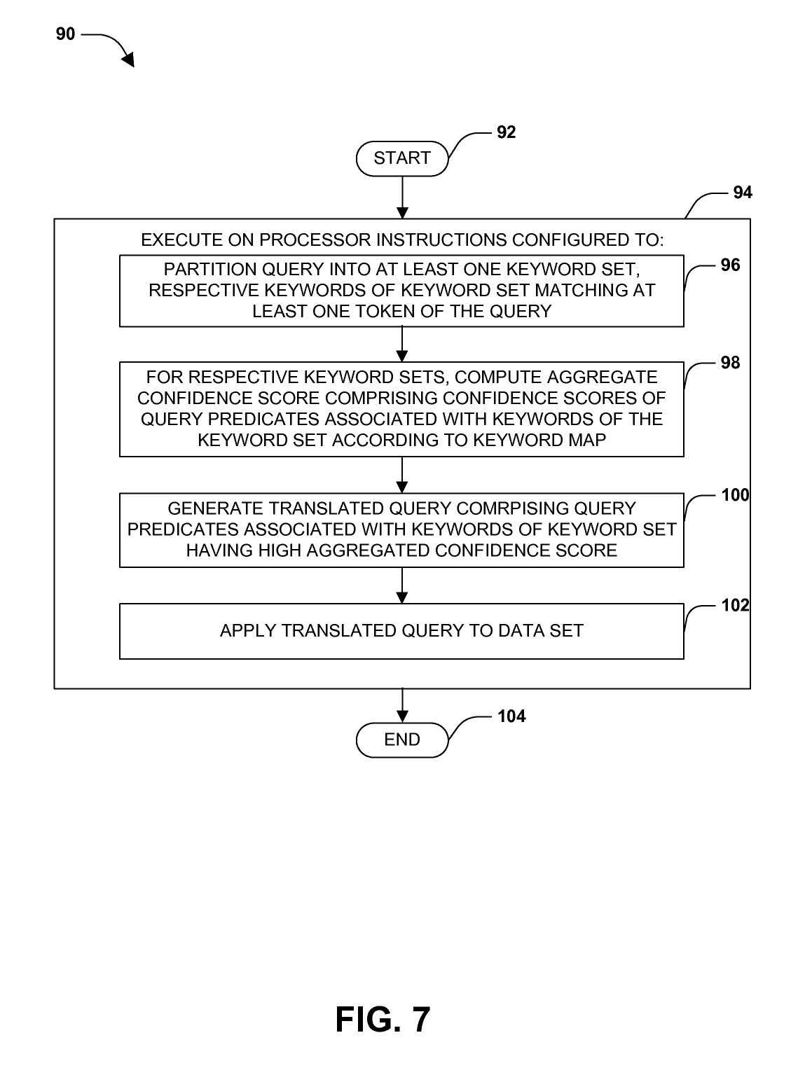

FIG. 7 presents a second exemplary embodiment of the techniques presented herein, illustrated as an exemplary method 90 of applying a query 18 comprising at least one token 62 to a data set 12. The exemplary method 90 may be performed on a device having a processor and a keyword map 48 associating respective keywords 20 with a query predicate 44 and a confidence score 46, which may have been prepared, e.g., according to the exemplary method 70 of FIG. 6. This exemplary method 90 of FIG. 7 begins at 92 and involves executing 94 on the processor instructions configured to perform the techniques presented herein (such as in the exemplary scenario 60 of FIG. 5.) In particular, the instructions are configured to partition 96 the query 18 into at least one keyword set 64, where respective keywords 20 of the keyword set 64 matching at least one token 62 of the query 18. The instructions are also configured to, for respective keyword sets 64, compute 98 an aggregate confidence score 66 comprising the confidence scores 46 of the query predicates 44 associated with the keywords 32 of the keyword set 64 according to the keyword map 48. The instructions are also configured to generate 100 a translated query 52 comprising the query predicates 44 associated with the keywords 20 of a keyword set 64 having a high aggregate confidence score 66, and to apply 102 the translated query 52 to the data set 12. In this manner, the exemplary method 90 achieves an improved application of the query 18 to the data set 12 in a manner that generates query results 24 of greater relevance to the intent of the author of the query 18, and so ends at 104.

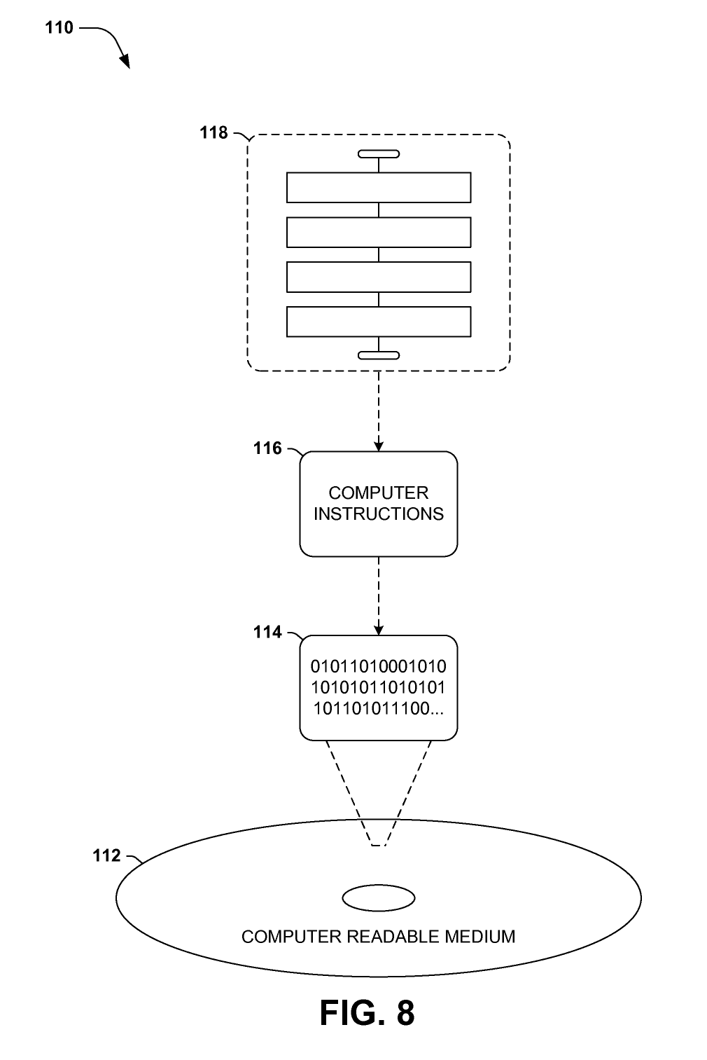

Still another embodiment involves a computer-readable medium comprising processor-executable instructions configured to apply the techniques presented herein. An exemplary computer-readable medium that may be devised in these ways is illustrated in FIG. 8, wherein the implementation 110 comprises a computer-readable medium 112 (e.g., a CD-R, DVD-R, or a platter of a hard disk drive), on which is encoded computer-readable data 114. This computer-readable data 114 in turn comprises a set of computer instructions 116 configured to operate according to the principles set forth herein. In one such embodiment, the processor-executable instructions 116 may be configured to perform a method of generating a keyword map 48 associating keywords 20 with query predicates 44 according to confidence scores 46, such as the exemplary method 70 of FIG. 6. In another such embodiment, the processor-executable instructions 116 may be configured to implement a method of applying a query 18 comprising at least one token 62 to a data set 12, such as the exemplary method 90 of FIG. 7. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques presented herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 70 of FIG. 6 and the exemplary method 90 of FIG. 7) to confer individual and/or synergistic advantages upon such embodiments.

A first aspect that may vary among embodiments of these techniques relates to the scenarios where such techniques may be utilized. As a first example, queries 18 translated and applied as disclosed herein may be applied to many types of data sets 12, such as relational databases, object libraries or collections, declarative documents formatted in various ways (such as according to an Extensible Markup Language (XML) schema), flat files, and sets of resources. As a second example of this first aspect, the data stored within such data sets 12 may represent many concepts, such as sets of real-world or virtual resources or structured bodies of information. As a third example of this first aspect, the queries 18 applied to such data sets 12 may be specified in many ways, including natural language queries, Boolean queries, or field-specific queries that are to be applied to particular attributes 14 of the data sets 12. Similarly, the query predicates 44 may be specified and used in many ways, such as query fragments specified in a structured language query (SQL) or XPath query language, or as references to particular attributes 14 of the data set 12 and different constraints to be applied thereto. As a fourth example of this first aspect, the query pairs may be manually generated, or may be mined from many types of query set 42 storing queries 18 including query pairs 34 regarding a particular keyword 32 of interest, including a historic log of queries previously submitted by users, a fabricated query set created by an administrator of the data set 12 to populate the keyword map 48, and an automatically generated set of queries 18 that might be submitted by users of the data set 12. Those of ordinary skill in the art may select many scenarios wherein the techniques presented herein may be utilized.

A second aspect that may vary among embodiments of these techniques relates to the manner of identifying one or more selectivity criteria while comparing query results 24 of the result sets 22 of the queries 18 in a query pair 34 for a keyword 32 of interest. Because this identification leads to the inference of semantics (both in isolation and in context) of respective keywords 20, the manner of performing this identification may significantly affect the accuracy of the inference and the resulting relevance of the query results 24. In general, it may be advantageous to utilize statistical techniques for identifying consistent factors that differentiate the query results 24 of a foreground query 36 and a background query 38 of a query pair 34. In particular, artificial intelligence techniques may be trained and utilized to identify differences, such as an artificial neural network or a genetic algorithm. Alternatively, some statistical techniques may be adept at identifying such differences, as well as calculating the confidence scores 46 of the identified selectivity criteria.

As a first example of this second aspect, the comparisons may be performed in many ways. In a first such variation, the comparison may identify one or more attributes 14 of the query results 24 of the foreground query 36 that happen to include the keyword 32 of interest, and these attributes 14 may be compared with the corresponding values of the attributes in the query results 24 of the result set 22 of the background query 38. In a second such variation, the query results 24 of the result set 22 of the foreground query 36 may be compared to identify consistent traits or patterns; the query results 24 of the result set 22 of the background query 38 may be compared to identify consistent traits or patterns; and the identified consistent traits or patterns of each result set 22 may be compared to identify differences between the queries 18 of the query pair 34. In a third such variation, the values of all attributes 14 of each query result 24 of the result sets 22 maybe compared, either in isolation or in combination, to identify patterns that may exhibit differences between the query results 24 of the result set 22 of the foreground query 36 and the query results 24 of the result set 22 of the background query 38. Those of ordinary skill in the art may devise other ways of comparing the result sets 22 of the foreground query 36 and the background query 38 of the query pair 34 while implementing the techniques presented herein.

A second example of this second aspect relates to the identification of selectivity criteria relating to categorical keywords, which may specify various options within a categorical attribute. A categorical attribute of a data set 12 comprises an attribute 14 for which valid values are constrained to a small set of categories, each represented by a keyword 20. For example, in the exemplary scenarios illustrated in FIGS. 2-3, the data set 12 includes a “Brand” attribute 14 for which the values for various data entries 16 are constrained to a small set of names of manufacturers, including “HiTech,” “Prestige,” and “Pyramid.” The values of the categorical attribute may be formatted as strings, but may also be formatted in other ways, such as characters, Boolean values, or numbers. (In many scenarios, the numbers may not semantically represent an order but rather may represent an unordered enumeration, e.g., where the value 1 is arbitrarily associated with the brand “HiTech” and the value 2 is arbitrarily associated with the brand“Prestige,” but no semantic meaning is implied or inferred based on the particular numbers associated with respective brands.)

In evaluating such categorical attributes, it may be advantageous to identify the selectivity criteria distinguishing the query results 24 of a foreground query 36 and a background query 38 of various query pairs 34 using an entropy or divergence calculation that identifies the magnitude of the differential probability distribution of the result sets 22. For example, where at least two keywords 20 comprising categorical keywords representing categorical values of a categorical attribute of the data set 12, the confidence scores 46 for respective categorical keywords may be computed according to a divergence computed between attribute values of results generated by the foreground queries 36 and the background queries 38 of the query pairs 32 identified in a query set 42 for the categorical keyword. One such computation that may be utilized in this role is the Kullback-Leibler divergence. This computation may be implemented for the techniques presented herein according to the following mathematical formula:

$$KL ( p ( v , A , {S}_{f} ) ‖ p ( v , A , {S}_{b} ) ) = p ( v , A , {S}_{f} ) log \frac{p ( v , A , {S}_{f} )}{p ( v , A , {S}_{b} )}$$

In this mathematical formula:

A represents the categorical attribute;

v represents a categorical value;

e represents a data entry included in the data set;

Sₑ represents the data set comprising the data entries e;

S_{f} represents the data entries e selected from the data set Sₑ as query results of the foreground query of the query pair;

S_{b} represents the data entries e selected from the data set Sₑ as query results of the background query of the query pair; and

p(v, A, S) represents a probability distribution of the categorical value v appearing within the categorical attribute A in the data set S, computed according to a mathematical formula comprising:

$$p ( v , A , S ) = \frac{\vert e [ A ] = v , e ∈ S \vert}{\vert S \vert} .$$

This mathematical formula may be utilized to compute the magnitude and statistical significance of the divergence between the query results 24 of the foreground query 36 and the query results 24 of the background query 38 of a query pair 34. A greater divergence may indicate a higher correlation of the categorical values of the categorical attribute with the keyword 32 of interest, and may promote the selection of one or more selectivity criteria that encapsulate the semantic intent of the keyword 32 in various queries 18.

Several variations in the mathematical formula may be devised (e.g., portions of the calculation may be implemented in different ways to promote faster or more efficient computation of the mathematical formula on various devices.) As one such variation, it may be appreciated that errors may arise if the background query 38 includes zero query results 24, which may result in an attempted division by zero. Therefore, the confidence scores 46 of the categorical keyword may be computed according to this mathematical formula of divergence only for query pairs 34 where the background query 38 comprises at least one query result 24.

A third example of this second aspect relates to the identification of selectivity criteria relating to numeric keywords, which may specify various numeric values within a numeric attribute. A categorical attribute of a data set 12 comprises an attribute 14 for which valid values represent numbers, such as physical measurements, performance or capacity metrics, prices, or dates. For example, in the exemplary scenarios illustrated in FIGS. 2-3, the data set 12 includes a “Weight” attribute 14, where the values included for respective data entries 16 identify the weight (in kilograms) of the represented devices.

In evaluating such numeric attributes, it may be advantageous to identify the selectivity criteria distinguishing the query results 24 of a foreground query 36 and a background query 38 of various query pairs 34 using a calculation that identifies the magnitude of the differential probability distribution of the numbers in the respective result sets 22. For example, where at least two keywords 20 comprising numeric keywords representing numeric values of a numeric attribute of the data set 12, the confidence scores 46 for respective numeric keywords may be computed according to an earth mover's distance computed between attribute values of results generated by the foreground queries 36 and the background queries 38 of the query pairs 32 identified in the query set 42 for the numeric keyword. This computation may be implemented for the techniques presented herein according to the following mathematical formula:

$$E M D ( P ( A , {S}_{f} ) , P ( A , {S}_{b} ) ) = {\sum }_{i = 1}^{n} {\sum }_{j = 1}^{n} {f}_{ij}^{*} d ( {v}_{i} , {v}_{j} )$$

In this mathematical formula:

A represents the numeric attribute;

e represents a data entry included in the data set;

Sₑ represents the data set comprising the data entries e;

S_{f} represents the data entries e selected from the data set Sₑ as query results of the foreground query of the query pair;

S_{b} represents the data entries e selected from the data set Sₑ as query results of the background query of the query pair;

vᵢ represents a numeric value within numeric attribute A;

d(vᵢ, vᵢ) represents a measure of dissimilarity between the query results selected from the data set having a numeric value vᵢ for the numeric attribute A and the query results selected from the data set having a numeric value vⱼ for the numeric attribute A;

fᵢⱼ represents a flow computed between optimizing the earth mover's distance the data entries e selected from the data set Sₑ as query results of the background query of the query pair, computed such that:

$${f}_{ij} \geq 0 , \\ 1 \leq i \leq n , \\ 1 \leq j \leq n , \\ {\sum }_{j = 1}^{n} {f}_{ij} \leq p ( {v}_{i} , A , {S}_{f} ) , 1 \leq i \leq n , and$$

$${\sum }_{i = 1}^{n} {f}_{ij} \leq p ( {v}_{j} , A , {S}_{b} ) , 1 \leq j \leq n ,$$

wherein:
p(v, A, S) represents a probability distribution of the categorical value v appearing within the categorical attribute A in the data set S, computed according to a mathematical formula comprising:

$$p ( v , A , S ) = \frac{\vert e [ A ] = v , e ∈ S \vert}{\vert S \vert} ;$$

and

fᵢⱼ* represents an optimal flow computed for the foreground queries S_{f} and the background queries S_{b} for the numeric values of the numeric attribute A.

This mathematical formula may be utilized to compute the magnitude and statistical significance of the divergence between the query results 24 of the foreground query 36 and the query results 24 of the background query 38 of a query pair 34. A greater divergence may indicate a higher correlation of the numeric values of the numeric attribute with the keyword 32 of interest, and may promote the selection of one or more selectivity criteria that encapsulate the semantic intent of the keyword 32 in various queries 18.

A fourth example of this second aspect relates to the identification of selectivity criteria relating to textual keywords, which may specify various text strings within a textual attribute. A textual attribute of a data set 12 comprises an attribute 14 storing a set of strings, and each keyword 20 may specify a full string or a substring that is stored in the textual attribute for one or more data entries 16. For example, in the exemplary scenarios illustrated in FIGS. 2-3, the data set 12 includes a “Description” attribute 14 for which the values for various data entries 16 are specified as strings that comprise natural-language text descriptions of the computer represented in the data set 12.

In evaluating such textual attributes, it may be advantageous to identify the selectivity criteria distinguishing the query results 24 of a foreground query 36 and a background query 38 of various query pairs 34 using a calculation that identifies the magnitude of the differential probability distribution of the numbers in the respective result sets 22. For example, where at least two keywords 20 comprising textual keywords representing textual values of a textual attribute of the data set 12, the confidence scores 46 for respective numeric keywords may be computed according to the ratio of the frequency with which the textual keyword appears in the textual attribute for the query results 24 of the foreground query 36 to the frequency with which the textual keyword appears in the textual attribute for the query results 24 of the background query 38. This calculation may count the total number of appearances of the textual keyword in the values of the textual attribute, or may count the number of textual attributes featuring at least one appearance of the textual keyword. The calculation may also scale the counting of the textual keyword by various factors (e.g., attributing a higher significance to the presence of the keyword earlier in the “Description” value of the textual attribute than to later appearances of the keyword in the same textual attribute.)

Additional variations of this fourth example of this second aspect relate to the application of a textual keywords against the data set 12 when it is not clear which attribute 14 the textual keywords are oriented to target. For example, the textual keyword may include an unusual term that does not often appear in the attributes 14 of the data entries 16 (or that does not appear often enough to identify a sufficient set of query pairs 34 for the keyword 32), or a recently added term that may be included in queries 18 but that does not yet appear often in the data set 12. In these and other scenarios, it may be advantageous, upon determining that a keyword 20 represents neither a categorical keyword (e.g., a valid value in any categorical attribute) nor a numeric keyword (e.g., a valid numeric value in any numeric attribute), an embodiment may be configured to associate the keyword 20 in the keyword map 48 with a query predicate 44 that applies a textual restriction to at least one textual attribute of the data set 12. For example, the evaluation of keywords 20 for the data set 12 in the exemplary scenarios of FIGS. 2-3 turns to the new keyword “multitouch,” but no such values may be found in the values of the attributes 14 of the data entries 16 of the data set 12 (or the term may appear too infrequently to identify a sufficient set of query pairs 34 for evaluation according to the techniques presented herein.) Instead, an embodiment may examine the data set 12 to identify at least one textual attribute that stores a natural language description of the data entries 16, such as the “Description” attribute 14. The embodiment may then store in the keyword map 48 a query predicate 44 that applies this keyword 20 to the “Description” attribute 14 (e.g., the SQL fragment “[Description]=‘&multitouch&”.) An embodiment might also formulate the query predicate 44 against a set of such textual attributes (e.g., “[Short Description]=‘&multitouch&’ or [Long Description]=‘&multitouch&’”) Such embodiments may therefore formulate an acceptable guess as to where the keyword might appear in future versions of the data set 12.

As an additional variation of this fourth example of this second aspect, the evaluation of textual keywords may be facilitated by the use of a dictionary, which may identify the attributes 14 against which a particular textual keyword may appear and the query predicates 44 formulated therefor. For example, an administrator of the data set 12 may choose to identify a set of keywords 20 that have known meanings, or at least known selectivity criteria within the data set 12. These identified keywords 20 may be stored in a dictionary as dictionary keywords, along with an indication of the intended meanings. An embodiment may, while evaluating various keywords 20 according to query pairs 34, determine whether the keyword 32 has a defined meaning according to the dictionary. This definition may be included in the identification of the selectivity criteria associated with the keyword 32, and the generation of a query predicate 44 that may be stored in the keyword map 48 associated with the keyword 32. In this manner, the meanings identified by the administrator may be included in the evaluation of the keyword 32, and may be encoded in the keyword map 48 for use in translating queries 18 for application to the data set 12. In a first variation, the dictionary keyword may be associated in the dictionary with a query predicate (such as a SQL fragment) that is to be used to translate instances of the dictionary keyword identified in queries 18 to be applied to the data set 12. In a second variation, the dictionary keyword may be associated in the dictionary with one or more attributes to which the keyword 20 likely relates, and on which an embodiment is to focus while comparing the query results 24 of the foreground query 36 and the background query 38 of a query pair 34.

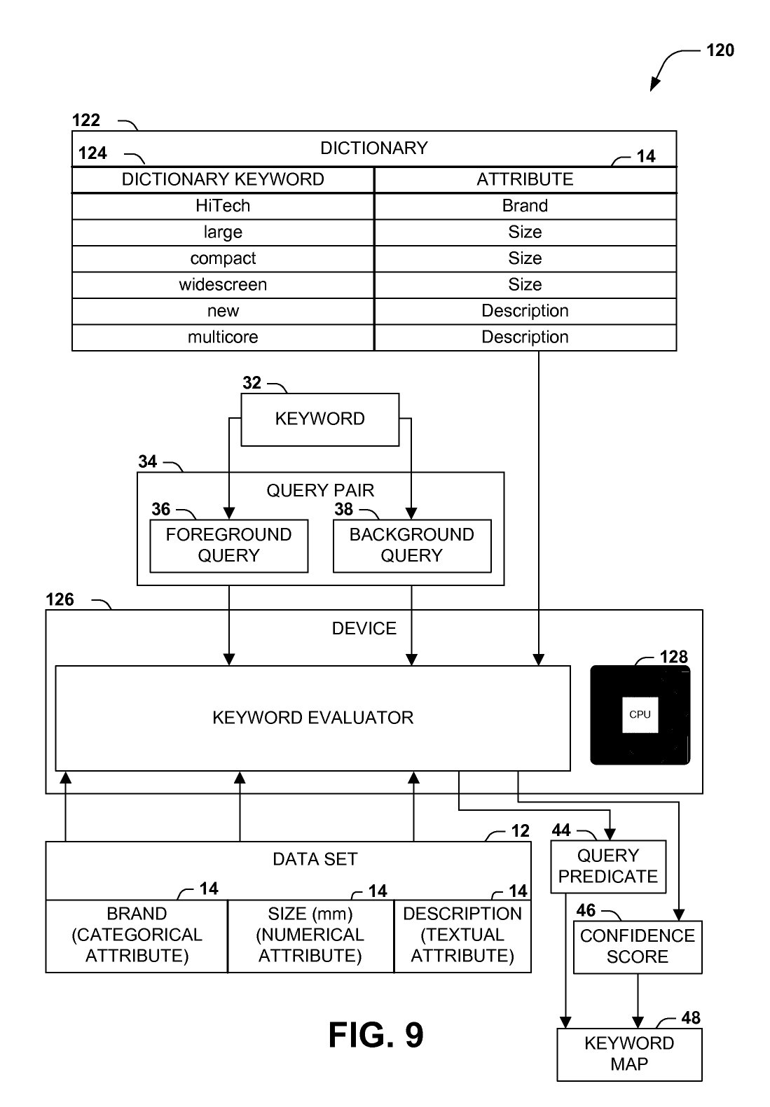

FIG. 9 presents an illustration of an exemplary scenario 120 featuring the evaluation of a textual keyword 32 by a device 126 having a processor 128, which may be configured to generate the keyword map 48 through the evaluation of query pairs 34 according to the techniques presented herein. In particular, this device 126 may perform the evaluation of textual keywords with reference to a dictionary 122, which relates various dictionary keywords 124 with various attributes 126 to which the dictionary keywords 124 are semantically related. For example, an administrator of the data set 12 may identify that particular dictionary keywords 124 are likely related to particular properties of represented aspects of the data entries 16 of the data set 12, and that such aspects may be reflected in particular attributes 14 of the data set 12. In this exemplary scenario 120, the administrator may have identified that the keyword 20 “HiTech” is likely related to the brand of a computer, and may create an entry in the dictionary 122 associating this keyword 20 (as a dictionary keyword 124) with the “Brand” attribute 14 of the data set 12; that the keywords 20 “large,” “compact,” and “widescreen” are likely related to the size of the computer, which may be reflected in the “Size” attribute 14 of the data set 12; and that the terms “new” and “multicore” may appear in a natural language description of the computer, which may be reflected in the “Description” attribute 14 of the data set 12. It may be appreciated that the simple technique for attributing relevance to the dictionary keywords 124 illustrated in this exemplary scenario 120 may serve to guide the evaluation of the keywords 32, while not necessarily constraining the keywords 20 to definitions formulated by the administrator (e.g., the administrator may not necessarily know or wish to select size parameters that characterize a computer as “large” or “compact,” and may wish these values to be automatically identified based on the techniques presented herein.)

In order to evaluate a textual keyword, the device 126 illustrated in the exemplary scenario 120 of FIG. 9 references the dictionary 122. In one such embodiment, upon detecting that a keywords 32 to be evaluated is included in the dictionary 122 as a dictionary keyword 124, the device 126 may be configured to limit its evaluation to the attribute(s) 14 associated with the dictionary keyword 124 in the dictionary 122. In another such embodiment, all attributes 14 may be evaluated, but the specified attribute(s) 14 may be preferentially selected as query predicates 44 if the confidence scores 46 of such attributes 14 are not significantly lower than the confidence scores 46 of other attributes 14 (which may indicate an error by the administrator of the data set 12 in associating the dictionary keyword 124 with the attribute 14 in the dictionary 122 when another attribute 14 may be more highly correlated.) Those of ordinary skill in the art may devise many techniques for formulating and utilizing the dictionary 122 in the evaluation of keywords 32, and more generally, for evaluating particular types of keywords 32 using the values of particular types of attributes 14, in accordance with the techniques presented herein.

A third aspect that may vary among embodiments of these techniques relates to the manner of applying the evaluative techniques presented herein to evaluate different types of keywords 20 to determine the meaning of such keywords 20. It may be appreciated that different embodiments may differently apply such evaluation techniques to the query pairs 34 for various keywords 32, and that some applications may have advantages (e.g., in accuracy, scalability, and/or computational efficiency) as compared with other applications.

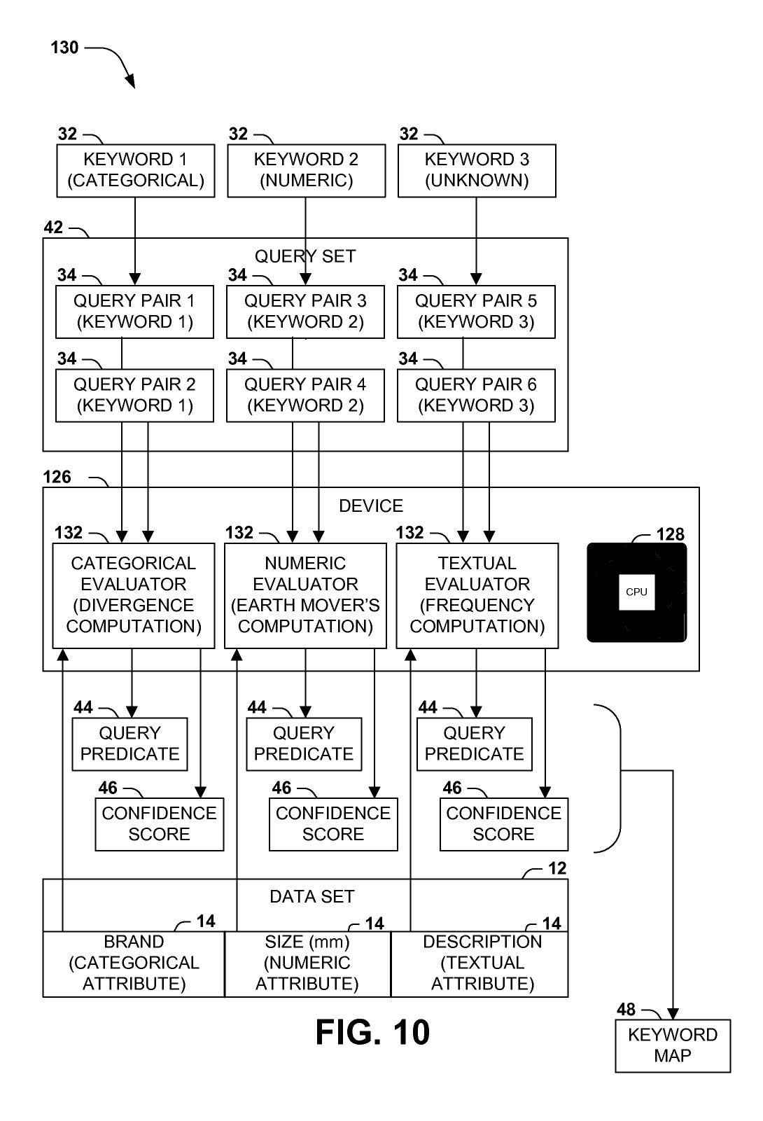

FIG. 10 presents an illustration of an exemplary scenario 130 featuring an exemplary application of the evaluation techniques for keywords 32 of various keyword types according to these different variations of the second aspect. In this exemplary scenario 130, a device 126 having a processor 128 performs the evaluation of various keywords 32 by evaluating query results 24 drawn from a data set 12 for various query pairs 34 in accordance with the techniques presented herein. As a general overview (and to recap the application of the techniques presented herein), for the first keyword 32, various query pairs 34 may be identified (comprising a background query 38 comprising a keyword set but excluding the keyword 32, and a foreground query 36 comprising the same keyword set but including the keyword 32), and the result sets 22 of these queries 18 may be compared to identify selectivity criteria. In particular, while comparing the query results 24 of the result sets 22 for the queries 18 of a query pair 34, the device 126 may iterative over the attributes 14 of the data set 12, and for each attribute 14, may compare the values for the attribute 14 for the query results 24 of the foreground query 36 with the query results 24 of the background query 38. The detection of a pattern of differences among the values of the particular attribute 14 between the query results 24 of the foreground query 36 and the query results 24 of the background query 38 may be identified as a selectivity criterion associated with the keyword 32 for this query pair 34, based on this attribute 14. A consistent detection of the same pattern of differences among all query pairs 34 for the keyword 32, based on the values of the attribute 14, may be identified as the selectivity criterion for the keyword 32, from which a query predicate 44 may be generated (drawn against the attribute 14) and stored in the keyword map 48 associated with the keyword 32. Moreover, the consistency and significance of the selectivity criterion among the query pairs 34 may be quantified as a confidence store 46 that is also stored in the keyword map 48 associated with the keyword 32 and the query predicate 44. Multiple keywords 32 may be evaluated and recorded in the keyword map 48 in this manner.

More particularly, the exemplary scenario 130 of FIG. 10 relates to the manner of evaluating the values of a particular attribute 14 of the data set 12 for query results 24 of a query pair 34 for a particular keyword 32. In this exemplary scenario 130, respective keywords 32 may feature different types of values, such as a first keyword 32 of a categorical type (drawn against a categorical attribute of the data set 12), a second keyword 32 of a numeric type (drawn against a numeric attribute of the data set), and a third keyword 32 of a textual type (drawn against a textual attribute of the data set.) Accordingly, the device 126 may include a set of keyword evaluators 132, each configured to compare the values of an attribute of a particular type for the query results 24 of the foreground query 36 to those of the query results 24 of the background query 38. For example, the set of keyword evaluators 132 may include a categorical keyword evaluator that is configured to compare the values of the attribute 14 between the result sets 22 as if they represent categorical values for a categorical attribute (e.g., according to a computed divergence); a numeric keyword evaluator that is configured to compare the values of the attribute 14 between the result sets 22 as if they represent categorical values for a categorical attribute (e.g., according to a computed earth mover's distance); and a textual keyword evaluator that is configured to compare the values of the attribute 14 between the result sets 22 as if they represent textual values for a textual attribute (e.g., according to a frequency of appearance of the textual keyword.) Each keyword evaluator 132 may generate a query predicate 44 and a confidence score 46 based on the particular evaluation technique. However, the device 126 may not be able to determine with certainty either the type of each keyword 32 (which may simply be formatted as a number or an alphanumeric string) or the type of an attribute 14 under consideration, and therefore may be unable to choose which keyword evaluator 132 to use. Therefore, the device 126 may evaluate the values of the attribute 14 for the query results 24 of each query 18 by invoking each keyword evaluator 132 on the values to compute the confidence scores 46 according to different techniques. One such technique (which more consistently corresponds to the type of the attribute 14 and the values) may generate a higher confidence score 46 than the others, and the device 126 may select the query predicate 44 and the confidence score 46 generated by this keyword evaluator 132 for this query pair 34. If the device 126 consistently selects a particular keyword evaluator 132 for all of the query pairs 34 for a particular keyword 32, then the keyword 32 may be presumed to be of the keyword type corresponding to the selected keyword evaluator 132.

In the exemplary scenario 130 of FIG. 10, in order to evaluate the first keyword 32 (which comprises a categorical keyword), the device 126 may first identify many query pairs 34 for the keyword 32. For each query pair 34, the device 126 may iterate over the attributes 14 of the data set 12, and may compare the values of the attribute 14 for the query results 24 of the foreground query 36 with the values of the attributes 14 for the query results 24 of the background query 38. In each iteration (selecting one attribute 14), the device 126 may invoke each of the keyword evaluators 132, each of which generates a query predicate 44 and a confidence score 46 for the attribute 14 and the query pair 34. The device 126 may compare the confidence scores 46 generated by the keyword evaluators 132, and may select the results of the keyword evaluator 132 that generates a high confidence score 46. The device 126 may then iterate over the remaining attributes 14, and may select the query predicate 44 generated by a keyword evaluator 132 with an acceptably high confidence score 46 among all attributes 14 for this query pair 34. Additional query pairs 34 for the first keyword 32 may be evaluated in this manner, and consistent results may be used to select a particular query predicate 44. For example, if the first keyword 32 comprises a categorical keyword 32 targeting the “Brand” attribute 14, it may be anticipated that the highest confidence scores 46 may be generated by applying the categorical keyword evaluator 132 to the values of the “Brand” attribute 14 for the foreground query 36 and the background query 38 for respective query pairs 34, and the device 126 may store in the keyword map 48, associated with the first keyword 32, a query predicate 44 that targets the “Brand” attribute 14.

While FIG. 10 and the foregoing discussion present one application of the keyword evaluation techniques presented herein to sets of query pairs 42 for various keywords 32, some variations of this third aspect may present additional advantages and/or reduce disadvantages. As a first example of this third aspect, in addition to selecting a query predicate 44 and a confidence score 46 for a particular keyword 32, the application of these techniques may also deduce the types of particular keywords and/or attribute(s) 14 identified in the query predicate 44 based on the selected keyword evaluator 132 (e.g., if, for a particular keyword 32, a categorical keyword evaluator returns higher confidence scores 46 for a particular attribute 14 than other keyword evaluators 132 consistently over many query pairs 34, in addition to targeting the identified attribute 14 in the query predicate 44 for the keyword 32, the device 126 may also conclude that both the keyword 32 and the attribute 14 are categorical in nature.) That is, after evaluating a few query pairs 34 and consistently selecting a particular keyword evaluator 132, the device 126 may presume that both the keyword 32 and the attribute 14 targeted by the keyword evaluator 132 are of the type evaluated by the selected keyword evaluator 132. This presumption may be utilized, e.g., by invoking only the selected keyword evaluator 132 while further evaluating the keyword 32 (and not invoking the other keyword evaluators 132 that evaluate the keyword as if it were a different type; e.g., if the keyword 32 is determined as likely being a categorical keyword, the device may forgo invoking the numeric keyword evaluator and the textual keyword evaluator while evaluating further query pairs 34 for the keyword 32.) This presumption may also be utilized, e.g., by invoking only the selected keyword evaluator 132 while evaluating the targeted attribute 14 for this and other keywords 32 (e.g., if the evaluation of several query pairs 34 for a particular keyword 32 result in high confidence scores 46 generated by a numeric keyword evaluator that targets a particular attribute 14, the attribute 14 may be presumed to contain numeric values, and the device may invoke only the numeric keyword evaluator, and may forgo invoking the categorical keyword evaluator and the textual keyword evaluator, while evaluating the values of query pairs 34 against this attribute 14 for this and other keywords 32).

As a second example of this third aspect, during the evaluation of the values of a particular attribute 14 for the query results 24 of various queries 18 in a query pair 34 for a keyword 32, the device 126 may be configured to invoke all of the keyword evaluators 132, and to select the query predicate 44 having the highest confidence score 46 among all invoked keyword evaluators 132. However, the invocation of each keyword evaluator 132 may be computationally costly, and if a particular keyword evaluator 132 returns a particularly high result (reflecting a high degree of correlation), an alternative embodiment may conserve computing resources by forgoing or terminating the invocation of the other keyword evaluators 132, thereby conserving computing resources and improving the performance of the evaluation.

As a third example of this third aspect, the device 126 may endeavor to populate the keyword map 48 only with query predicates 44 for which the confidence score 46 are acceptably high. For example, it may be appreciated that some keywords 32 may not have a consistent or determinable meaning, and the result sets 24 of the foreground queries 36 and background queries 38 of respective query pairs 34 for the keyword 32 may differ only in arbitrary ways, leading to low confidence scores 46. This may arise, e.g., where the keyword 32 comprises a generic term, such as “computer,” which may by happenstance appear in the natural language “Description” attributes for some data entries 14 but not others, thereby leading to query pairs 34 having only arbitrary differences. As a first variation of this third example, an embodiment may store the query predicate 44 and the confidence score 46 in the keyword map 48 only if the confidence score 46 is acceptably high, e.g., if the confidence score 46 exceeds a confidence score threshold. Moreover, the confidence score threshold may be adjusted relative to various factors, such as the number of query pairs 34 evaluated for the keyword 32; e.g., a somewhat lower confidence score 46 may be acceptable if resulting from the evaluation of many query pairs 34, but may not be acceptable if only a few query pairs 34 are available for the keyword 32. Additionally, it may be advantageous to normalize the confidence score 46 for the keyword 32 respective to the adjusted confidence score threshold (e.g., such that respective confidence scores 46 reflect the number of query pairs 34 evaluated in determining the confidence score 46). As a second variation of this third example, the embodiment may, upon failing to identify a query predicate 44 with an acceptably high confidence score 46, associate the keyword 32 with a default attribute, such as the “Description” attribute 14 in the data set 12 illustrated in the exemplary scenario of FIGS. 2-3. As a third variation of this third example, the embodiment may regard any keyword 32 that fails to generate a query predicate 44 with an acceptably high confidence score 46 as a “stop word,” which may not be evaluated during the application of subsequent queries 18 to the data set 12. For example, keywords 32 such as “the,” “best,” and “computer” may not have any semantic meaning when included in a query 18 over the data set 12 of FIGS. 2-3, and may be treated as stop words. One such embodiment may implement this variation by, for any keyword 32 presumed to be a stop word, storing in the keyword map 48 a query predicate 44 comprising the value “TRUE,” which (if aggregated into an SQL query) may simply bypass the corresponding keyword 32 without evaluation.

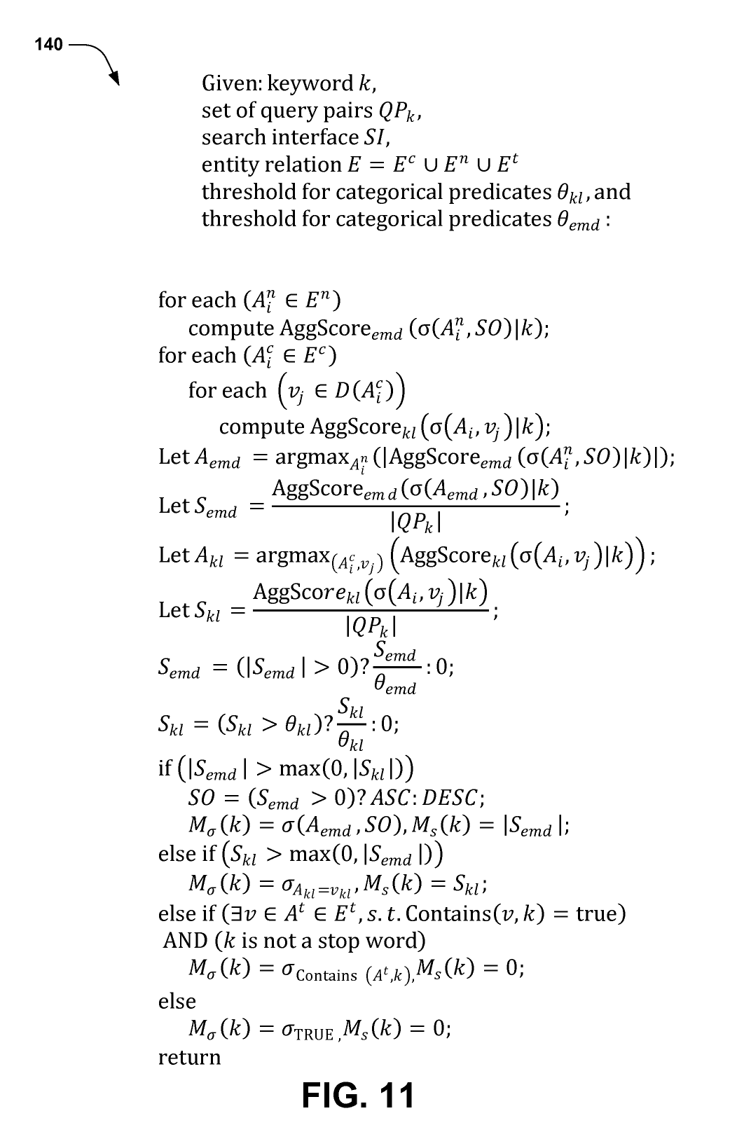

FIG. 11 presents an exemplary algorithm 140 whereby several of the techniques presented herein may be applied while evaluating the query pairs 34 (represented as QPₖ) for a keyword 18 (represented as k) in view of a data set 12 (represented as entity relation E having various types of attributes 14 represented as E^{c} for categorical attributes, Eⁿ for numeric attributes, and E^{t} representing textual attributes.) While the details of this algorithm may be understood with respect to the techniques presented herein, the following general description may facilitate this understanding. According to this algorithm, the query results 24 for a particular query 18 of the query pair 34 are identified by invoking a search interface (represented as SI) over the data entries 16 in the entity relation E, where each search is represented by the symbol σ. According to this exemplary algorithm 140, for each attribute 14 of the entity relation E, a first aggregate confidence score is identified using the earth mover's distance computation (represented as emd), and a second aggregate confidence score is identified using the Kullback-Leibler divergence computation (represented as kl) for each categorical value (each value represented as vⱼ in the set of acceptable values D over the attribute A^{c}.) The maximum confidence score 46 is then selected, as well as the average confidence computed cross all query pairs 34 for the keyword 32 normalized according to corresponding confidence score thresholds (represented as θₑₘₗ and θₖₗ) and the number of query pairs 34 evaluated. The average confidence score 46 computed according to the earth mover's distance computation and the average confidence score 46 computed according to the Kullback-Leibler divergence computation may be compared, and the evaluation technique generating the higher confidence score 46 may be selected for the generation of a query predicate 44 (represented as M_{σ}(k)) and the confidence score 46 (represented as Ms(k).) In the event that the earth mover's distance is selected upon detecting an order over a numeric attribute, an ascending or descending search order (represented as SO) may be selected to be applied in the query predicate 44 for the numeric attribute, based on whether the earth mover's distance computation is positive or negative. However, if neither evaluation technique produces an acceptably high confidence score 46, the data set 12 may be examined to determine whether any textual attribute contains the keyword 32; if so (and if the keyword 32 does not comprise a stop word), this attribute 14 may be selected for the generation of a query predicate 44. Finally, if the keyword 32 is a stop word or if no textual match can be identified among the attributes 14 of the data set 12, a stop word query predicate (e.g., “TRUE”) may be selected. In this manner, the algorithm utilizes the techniques presented herein to generate query predicates 44 and confidence scores 46 for respective keywords 32. Those of ordinary skill in the art may devise many such algorithms while implementing the techniques presented herein.

A fourth aspect that may vary among embodiments of these techniques relates to the manner of translating a query 18 into a translated query 52 using the keyword map 48. As a first example, depending on the nature of the query predicates 44 stored in the keyword map 48, the translated query 52 may be generated in various ways. In a first such variation, if the query predicates comprise SQL fragments. For example, if keyword 20 “HiTech” is associated with the keyword predicate 44 “brand=‘HiTech’”, and the keyword 20 “light” is associated with the keyword predicate 44 “weight <7.0”, then the translated query 52 may be translated from the query “light HiTech” as the following SQL query: “select * from Computers where (weight <7.0) and (brand=‘HiTech’)”.

As a second example of this fourth aspect, an embodiment may examine the query predicates 44 to identify advantageous combinations thereof. As a first such variation, if a particular attribute 14 is targeted by two or more query predicates 44, it may be advantageous to combine these query predicates 44 in an inclusive manner. For example, a query “HiTech Pyramid laptop” may lead to the selection of query predicates 44 “brand=‘HiTech’” and “brand=‘Pyramid’”. Because no data entry 16 is likely to satisfy both query predicates 44, this query 18 is likely to fail to return any query results 24 if these query predicates 44 are combined with a logical AND connector. However, it may be inferred that the author of the query intended to query for laptop computers manufactured by either HiTech or Pyramid. Thus, an embodiment of these techniques may identify that both query predicates 44 target the same attribute 14, and may translate these query predicates 44 into the translated query 52 with a logical OR connector. As a second such variation, a query predicate 44 that targets a numeric attribute 14 may specify this query restriction in various ways, such as a numeric range (e.g., the keyword 20 “light” might be translated as the query predicate 44 “weight <7.0”.) Alternatively, such a query predicate 44 may be translated as an order, such that data entries 16 that are closer to a particular value are presented higher in the query results 24 of the query 18 than data entries 16 that are farther away from the particular value (e.g., the keyword 20 “light” might be translated as the query predicate 44 “order by [weight] asc”, thereby ordering the query results 24 in order of lowest weight to highest weight.)

As a third example of this fourth aspect, the identification of keywords 20 in a query 18 may be performed in various ways. As a first example, the query 18 may simply be partitioned in various ways (e.g., by partitioning based on whitespace), and each token may be identified as a keyword 20 to be translated into the translated query 52 using the keyword map 48. While this simple technique may be advantageous where each keyword 20 comprises a single word, it may produce undesirable results for keywords 20 that involve multiple words. For example, this technique may fail to partition the query 18 “small business laptop” into the likely intended keywords 20 “small business” and “laptop” (indicating a laptop computer suitably configured for use in a small business environment), but may instead partition the query 18 into the keywords 20 “small,” “business,” and “laptop,” thereby querying the data set 12 for laptop computers that are small and have some connection with business (which may be construed as an arbitrary modifier or a stop word), leading to inaccurate search results. Instead, the query 18 may be parsed with reference to the keyword map 48, which may facilitate the partitioning of the tokens 62 of the query 18 into a set of keywords 20 having a high aggregate confidence score 66, thereby suggesting the contextual combination of tokens 62 coincident with the inferred intent of the author of the query 18. The exemplary scenario 60 of FIG. 5 and the exemplary method 90 of FIG. 7 each illustrate a version of this technique.

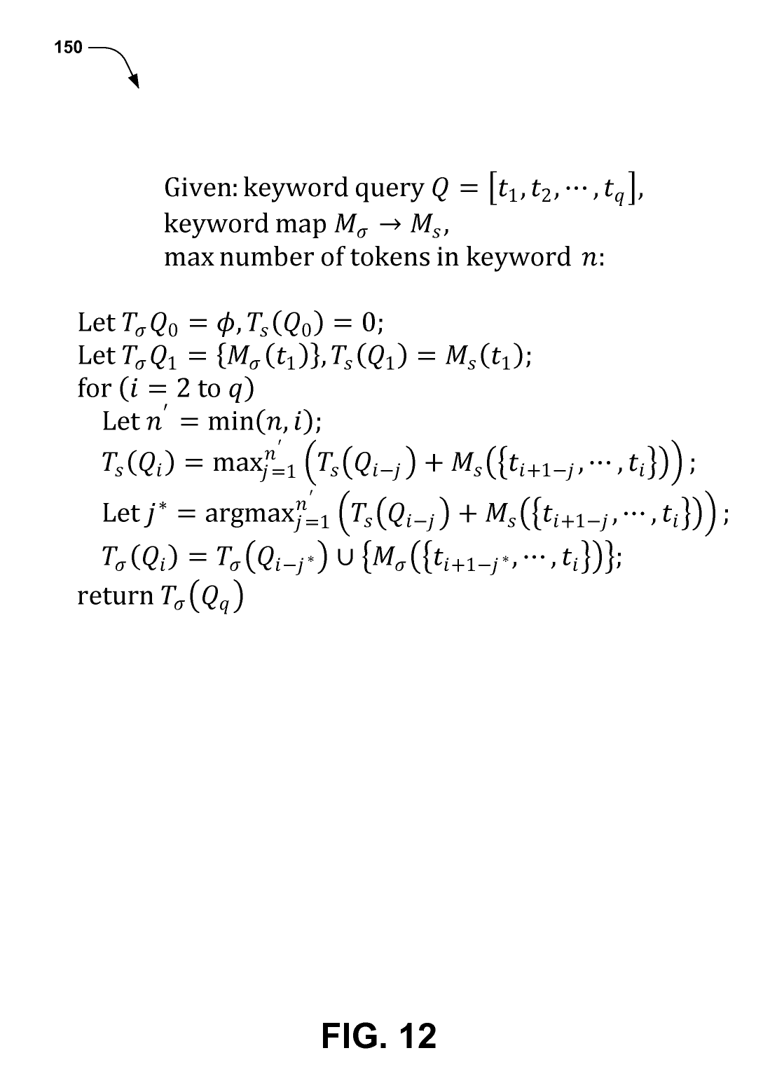

FIG. 12 presents an exemplary algorithm 150 that may be utilized to partition tokens 62 (represented as t₁, t₂ . . . , tₙ) of a query 18 (represented as Q) according to these techniques, where each keyword 20 may comprise up to n tokens 62. While the details of this algorithm may be understood with respect to the techniques presented herein, the following general description may facilitate this understanding. According to this exemplary algorithm 150, a first keyword 20 may be assembled from the first token 62 in the query 18, and the confidence score 46 of this first keyword 20 may be computed. Other confidence scores 46 may be computed by adding succeeding tokens 62 to the first keyword 20 (up to an n′ number of tokens 62, where n′ represents either the lower of the remaining number of available tokens 62 in the query and the maximum of n tokens 62.) The combination having the maximum confidence score 46, according to the keyword map 46 may be selected, and the tokens 62 of this combination may be removed from the query 18 as the first keyword 20; and if any tokens 62 remain in the query 18, the next keyword 20 may be selected through a successive evaluation of combinations of tokens 62 according to the confidence scores 46 of the keywords 20 stored in the keyword map 46. This technique may permit the preferential selection of the keyword 20 “large display” over separate keywords 20 “large” and “display,” each of which may have lower confidence scores 46 due to the comparatively less consistent and predictable semantic intent of each keyword 20 in a query 18 as compared with the combination thereof. This technique may also permit the evaluation of keywords 20 in the context of other keywords 20 (e.g., the keyword “small” may comprise a valid first meaning in the query 18 “small laptop,” but may comprise a different and more consistent second meaning in the query 18 “small business laptop,” due to the different context of the token 62 “small” imparted by the inclusion of the token 62 “business.”) Those of ordinary skill in the art may devise many techniques and algorithms for utilizing keyword maps 48 in the translation of queries 18 to translated queries 52 according to the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

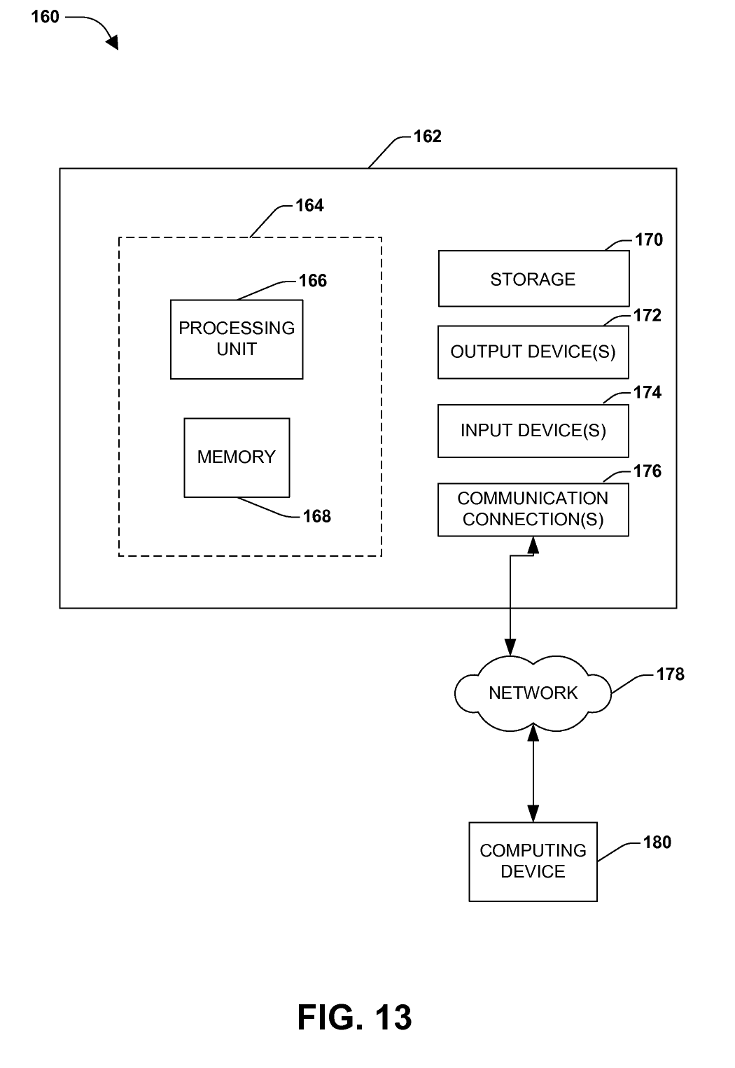

FIG. 13 and the following discussion provide a brief, general description of a suitable computing environment to implement embodiments of one or more of the provisions set forth herein. The operating environment of FIG. 13 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 13 illustrates an example of a system 160 comprising a computing device 162 configured to implement one or more embodiments provided herein. In one configuration, computing device 162 includes at least one processing unit 166 and memory 168. Depending on the exact configuration and type of computing device, memory 168 may be volatile (such as RAM, for example), non-volatile (such as ROM, flash memory, etc., for example) or some combination of the two. This configuration is illustrated in FIG. 13 by dashed line 164.

In other embodiments, device 162 may include additional features and/or functionality. For example, device 162 may also include additional storage (e.g., removable and/or non-removable) including, but not limited to, magnetic storage, optical storage, and the like. Such additional storage is illustrated in FIG. 13 by storage 170. In one embodiment, computer readable instructions to implement one or more embodiments provided herein may be in storage 170. Storage 170 may also store other computer readable instructions to implement an operating system, an application program, and the like. Computer readable instructions may be loaded in memory 168 for execution by processing unit 166, for example.

The term “computer readable media” as used herein includes computer storage media. Computer storage media includes volatile and nonvolatile, removable and non-removable media implemented in any method or technology for storage of information such as computer readable instructions or other data. Memory 168 and storage 170 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 162. Any such computer storage media may be part of device 162.

Device 162 may also include communication connection(s) 176 that allows device 162 to communicate with other devices. Communication connection(s) 176 may include, but is not limited to, a modem, a Network Interface Card (NIC), an integrated network interface, a radio frequency transmitter/receiver, an infrared port, a USB connection, or other interfaces for connecting computing device 162 to other computing devices. Communication connection(s) 176 may include a wired connection or a wireless connection. Communication connection(s) 176 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 162 may include input device(s) 174 such as keyboard, mouse, pen, voice input device, touch input device, infrared cameras, video input devices, and/or any other input device. Output device(s) 172 such as one or more displays, speakers, printers, and/or any other output device may also be included in device 162. Input device(s) 174 and output device(s) 172 may be connected to device 162 via a wired connection, wireless connection, or any combination thereof. In one embodiment, an input device or an output device from another computing device may be used as input device(s) 174 or output device(s) 172 for computing device 162.

Components of computing device 162 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 162 may be interconnected by a network. For example, memory 168 may be comprised of multiple physical memory units located in different physical locations interconnected by a network.

Those skilled in the art will realize that storage devices utilized to store computer readable instructions may be distributed across a network. For example, a computing device 180 accessible via network 178 may store computer readable instructions to implement one or more embodiments provided herein. Computing device 162 may access computing device 180 and download a part or all of the computer readable instructions for execution. Alternatively, computing device 162 may download pieces of the computer readable instructions, as needed, or some instructions may be executed at computing device 162 and some at computing device 180.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of generating, on a device having a processor using at least one query comprising at least one keyword and at least one query result selected from the data set according to the query, a keyword map associating respective keywords with a query predicate, the method comprising:
executing on the processor instructions configured to, for respective keywords:
identify at least one query pair comprising a background query comprising a keyword set excluding the keyword and a foreground query comprising the keyword set and the keyword;
for respective query pairs, compare the query results of the background query and the query results of the foreground query to identify a selectivity criterion; and
associate the keyword in the keyword map with a query predicate matching the selectivity criteria of the query pairs according to a confidence score.

2. The method of claim 1:
at least two keywords representing categorical keywords representing categorical values of a categorical attribute of the data set; and
the confidence score of a categorical keyword computed according to a divergence between attribute values of results generated by the foreground queries and the background queries of the query pairs for the categorical keyword.

3. The method of claim 2, the divergence computed as a Kullback-Leibler divergence according to a mathematical formula comprising:
$$KL ( p ( v , A , {S}_{f} ) \vert \vert p ( v , A , {S}_{b} ) ) = p ( v , A , {S}_{f} ) log \frac{p ( v , A , {S}_{f} )}{p ( v , A , {S}_{b} )}$$
wherein:
A represents the categorical attribute;
v represents a categorical value;
e represents a data entry included in the data set;
Sₑ represents the data set comprising the data entries e;
S_{f} represents the data entries e selected from the data set Sₑ as query results of the foreground query of the query pair;
S_{b} represents the data entries e selected from the data set Sₑ as query results of the background query of the query pair; and
p(v, A, S) represents a probability distribution of the categorical value v appearing within the categorical attribute A in the data set S, computed according to a mathematical formula comprising:
$$p ( v , A , S ) = \frac{\vert e [ A ] = v , e ∈ S \vert}{\vert S \vert} .$$

4. The method of claim 2, the confidence score of the categorical keyword computed according to the divergences of query pairs comprising a background query having at least one query result.

5. The method of claim 1:
at least two keywords representing numeric keywords representing numeric values of a numeric attribute of the data set; and
the confidence score of a numeric keyword computed according to an earth mover's distance between attribute values of results generated by the foreground queries and the background queries of the query pairs for the numeric keyword.

6. The method of claim 5, the earth mover's distance computed according to a mathematical formula comprising:
$$E M D ( P ( A , {S}_{f} ) , P ( A , {S}_{b} ) ) = {\sum }_{i = 1}^{n} {\sum }_{j = 1}^{n} {f}_{ij}^{*} d ( {v}_{i} , {v}_{j} )$$
wherein:
A represents the numeric attribute;
e represents a data entry included in the data set;
Sₑ represents the data set comprising the data entries e;
S_{f} represents the data entries e selected from the data set Sₑ as query results of the foreground query of the query pair;
S_{b} represents the data entries e selected from the data set Sₑ as query results of the background query of the query pair;
vᵢ represents a numeric value within numeric attribute A;
d(vᵢ, vⱼ) represents a measure of dissimilarity between the query results selected from the data set having a numeric value vᵢ for the numeric attribute A and the query results selected from the data set having a numeric value vⱼ for the numeric attribute A;
fᵢⱼ represents a flow computed between optimizing the earth mover's distance the data entries e selected from the data set Sₑ as query results of the background query of the query pair, computed such that:
$${f}_{ij} \geq 0 , \\ 1 \leq i \leq n , \\ 1 \leq j \leq n , \\ {\sum }_{j = 1}^{n} {f}_{ij} \leq p ( {v}_{i} , A , {S}_{f} ) , 1 \leq i \leq n , and$$
$${\sum }_{i = 1}^{n} {f}_{ij} \leq p ( {v}_{j} , A , {S}_{b} ) , 1 \leq j \leq n ,$$
wherein:
p(v, A, S) represents a probability distribution of the categorical value v appearing within the categorical attribute A in the data set S, computed according to a mathematical formula comprising:
$$p ( v , A , S ) = \frac{\vert e [ A ] = v , e ∈ S \vert}{\vert S \vert} ;$$
and
fᵢⱼ* represents an optimal flow computed for the foreground queries S_{f} and the background queries S_{b} for the numeric values of the numeric attribute A.

7. The method of claim 1, comprising: upon determining that a keyword does not represent a categorical keyword and that the keyword does not represent a numeric keyword, associating the keyword in the keyword map with a query predicate applying a textual restriction to at least one textual attribute of the data set.

8. The method of claim 7:
the device having a dictionary associating at least one dictionary keyword with at least one attribute of the data set; and
the method comprising: for a keyword, upon identifying a dictionary keyword in the dictionary matching the keyword, associating the keyword in the keyword map with a query predicate associated with the attribute of the data set.

9. The method of claim 1, associating the keyword in the keyword map with a query predicate comprising: associating the keyword in the keyword map with a query predicate matching the selectivity criteria of the query pairs according to a confidence score if the confidence score exceeds a confidence score threshold.

10. The method of claim 9, comprising: selecting for the keyword a confidence score threshold that is inversely proportional to a number of query pairs identified for the keyword.

11. The method of claim 9, comprising: normalizing the confidence score associating the keyword with the query predicate in the keyword map according to the confidence score threshold.

12. The method of claim 1, the confidence scores of respective keywords computed according to a mathematical formula comprising:
$$AggScore ( σ \vert k ) = \frac{1}{n} {\sum }_{i = 1}^{n} Score ( σ \vert ( {Q}_{f}^{i} , {Q}_{b}^{i} ) )$$
wherein:
k represents the keyword;
e represents a data entry included in the data set;
Sₑ represents the data set comprising the data entries e;
QS(Sₑ) represents a query set of queries applied to the data set Sₑ;
(Q_{f}, Q_{b}) represents a query pair identified in the query set QS(Sₑ) for the keyword k, the query pair comprising foreground query Q_{f} and background query Q_{b};
n represents the number of query pairs identified in the query set QS(Sₑ) for the keyword k;
(Q_{f}ⁱ, Q_{b}ⁱ) represents the query pair i among query pairs (1 . . . n) identified in the query set QS(Sₑ) for the keyword k;
σ represents a query predicate corresponding to the keyword k; and
Score (σ|(Q_{f}, Q_{b})) represents a confidence score computed for the query predicate σ and the query pair (Q_{f}, Q_{b}).

13. The method of claim 12, computing the confidence scores of respective keywords comprising:
for respective attributes of the data set:
computing a categorical confidence score of the keyword as a categorical keyword associated with the attribute;
computing a numeric confidence score of the keyword as a numeric keyword associated with the attribute; and
computing a textual confidence score of the keyword as a textual keyword associated with the attribute;
identifying a maximum confidence score of the keyword among the categorical confidence scores, the numeric confidence scores, and the textual confidence scores for respective attributes; and
associating the keyword in the keyword map with a query predicate specifying the attribute according to the maximum confidence score.

14. The method of claim 12, the confidence score computed for query predicate σ and query pair (Q_{f}, Q_{b}) comprising:
if the query predicate σ is associated with a categorical keyword, a Kullback-Leibler divergence between the foreground query and the background query of the query pair (Q_{f}, Q_{b});
if the query predicate σ is associated with a numeric keyword, an earth mover's distance between the foreground query and the background query of the query pair (Q_{f}, Q_{b}); and
if the query predicate σ is associated with a textual keyword, a textual selectivity between the foreground query and the background query of the query pair (Q_{f}, Q_{b}).

15. A method of applying a query comprising at least one token to a data set on a device having a processor and a keyword map associating keywords with a query predicate and a confidence score, the method comprising:
executing on the processor instructions configured to:
partition the query into at least one keyword set, respective keywords of the keyword set matching at least one token of the query;
for respective keyword sets, compute an aggregate confidence score comprising the confidence scores of the query predicates associated with the keywords of the keyword set according to the keyword map;
generate a translated query comprising the query predicates associated with the keywords of a keyword set having a high aggregate confidence score; and
apply the translated query to the data set.

16. The method of claim 15, partitioning the query into at least one keyword set comprising, for a query portion comprising at least a first token and a second token:
computing a first token confidence score of a first keyword associated with the first token according to the keyword map;
computing a second token confidence score of a second keyword associated with the second token according to the keyword map;
computing an aggregated token confidence score of a third keyword associated with the first token and the second token according to the keyword map;
if the first token confidence score and the second token confidence score exceed the aggregated token confidence score, partitioning the query into the first keyword associated with the first token and a query portion comprising at least the second token; and
if the aggregated token confidence score exceeds the first token confidence score and the second token confidence score, partitioning the query into the third keyword associated with the first token and the second token.

17. The method of claim 15:
a keyword set comprising a first keyword associated with a first query predicate and a second keyword associated with a second query predicate, where the first query predicate and the second query predicate relate to an attribute of the data set; and
generating a translated query for the keyword set comprising: generating a translated query joining the first query predicate and the second query predicate with a logical OR connector.

18. The method of claim 15:
a keyword set comprising a numeric keyword associated with a numeric attribute of the data set;
the keyword map identifying, for the numeric keyword, a numeric range associated with the numeric attribute of the data set; and
generating a translated query for the keyword set comprising: generating a translated query comprising a query predicate representing the numeric keyword as a numeric range within the numeric attribute.

19. The method of claim 15:
a keyword set comprising a numeric keyword associated with a numeric attribute of the data set;
the keyword map identifying, for the numeric keyword, a numeric order associated with the numeric attribute of the data set; and
generating a translated query for the keyword set comprising: generating a translated query comprising a query predicate representing the numeric keyword as a numeric order within the numeric attribute.

20. A computer-readable medium comprising instructions that, when executed on a device having a processor, a query set comprising a data set and at least one query comprising at least one keyword and at least one query result selected from the data set according to the query, and a dictionary associating at least one dictionary keyword with at least one attribute of the data set, apply a query comprising at least one token to the data set by:
generating a keyword map associating respective keywords with a query predicate by:
identifying within the query set at least one query pair comprising a background query comprising a keyword set excluding the keyword and a foreground query comprising the keyword set and the keyword;
for respective query pairs, comparing the query results of the background query and the query results of the foreground query to identify a selectivity criterion; and
associating the keyword in the keyword map with a query predicate matching the selectivity criteria of the query pairs according to a confidence score, wherein:
the confidence scores of categorical keywords respectively representing a categorical keyword of a categorical attribute of the data set are computed according to a Kullback-Leibler divergence between the foreground queries and the background queries of the query pairs identified in the query set for the categorical keyword, the Kullback-Leibler divergence computed according to a mathematical formula comprising:
$$KL ( p ( v , A , {S}_{f} ) \vert \vert p ( v , A , {S}_{b} ) ) = p ( v , A , {S}_{f} ) log \frac{p ( v , A , {S}_{f} )}{p ( v , A , {S}_{b} )}$$
wherein:
A represents the categorical attribute;
v represents a categorical value;
e represents a data entry included in the data set;
Sₑ represents the data set comprising the data entries e;
S_{f} represents the data entries e selected from the data set Sₑ as query results of the foreground query of the query pair;
S_{b} represents the data entries e selected from the data set Sₑ as query results of the background query of the query pair; and
p(v, A, S) represents a probability distribution of the categorical value v appearing within the categorical attribute A in the data set S, computed according to a mathematical formula comprising:
$$p ( v , A , S ) = \frac{\vert e [ A ] = v , e ∈ S \vert}{\vert S \vert} ;$$
the confidence scores of numeric keywords respectively representing numeric values of a numeric attribute of the data set are computed according to an earth mover's distance between the foreground queries and the background queries of the query pairs identified in the query set for the numeric keyword, the earth mover's distance computed according to a mathematical formula comprising:
$$E M D ( P ( A , {S}_{f} ) , P ( A , {S}_{b} ) ) = {\sum }_{i = 1}^{n} {\sum }_{j = 1}^{n} {f}_{ij}^{*} d ( {v}_{i} , {v}_{j} )$$
wherein:
A represents the numeric attribute;
e represents a data entry included in the data set;
Sₑ represents the data set comprising the data entries e;
S_{f} represents the data entries e selected from the data set Sₑ as query results of the foreground query of the query pair;
S_{b} represents the data entries e selected from the data set Sₑ as query results of the background query of the query pair;
vᵢ represents a numeric value within numeric attribute A;
d(vᵢ, vⱼ) represents a measure of dissimilarity between the query results selected from the data set having a numeric value vᵢ for the numeric attribute A and the query results selected from the data set having a numeric value vⱼ for the numeric attribute A;
fᵢⱼ represents a flow computed between optimizing the earth mover's distance the data entries e selected from the data set Sₑ as query results of the background query of the query pair, computed such that:
$${f}_{ij} \geq 0 , \\ 1 \leq i \leq n , \\ 1 \leq j \leq n , \\ {\sum }_{j = 1}^{n} {f}_{ij} \leq p ( {v}_{i} , A , {S}_{f} ) , 1 \leq i \leq n , and$$
$${\sum }_{i = 1}^{n} {f}_{ij} \leq p ( {v}_{j} , A , {S}_{b} ) , 1 \leq j \leq n ,$$
wherein:
p(v, A, S) represents a probability distribution of the categorical value v appearing within the categorical attribute A in the data set S, computed according to a mathematical formula comprising:
$$p ( v , A , S ) = \frac{\vert e [ A ] = v , e ∈ S \vert}{\vert S \vert} ;$$
and
fᵢⱼ* represents an optimal flow computed for the foreground queries S_{f} and the background queries S_{b} for the numeric values of the numeric attribute A,
wherein computing a confidence score for a keyword comprises:
for respective attributes of the data set:
computing a categorical confidence score of the keyword as a categorical keyword associated with the attribute;
computing a numeric confidence score of the keyword as a numeric keyword associated with the attribute; and
computing a textual confidence score of the keyword as a textual keyword associated with the attribute;
identifying a maximum confidence score of the keyword among the categorical confidence scores, the numeric confidence scores, and the textual confidence scores for respective attributes; and
associating the keyword in the keyword map with a query predicate specifying the attribute according to the maximum confidence score if the confidence score exceeds a confidence score threshold that is inversely proportional to a number of query pairs identified for the keyword in the query set, the confidence scores of respective keywords computed according to a mathematical formula comprising:
$$AggScore ( σ \vert k ) = \frac{1}{n} {\sum }_{i = 1}^{n} Score ( σ \vert ( {Q}_{f}^{i} , {Q}_{b}^{i} ) )$$
wherein:
k represents the keyword;
e represents a data entry included in the data set;
Sₑ represents the data set comprising the data entries e;
QS(Sₑ) represents the query set of queries applied to the data set Sₑ;
(Q_{f}, Q_{b}) represents a query pair identified in the query set QS(Sₑ) for the keyword k, the query pair comprising foreground query Q_{f} and background query Q_{b};
n represents the number of query pairs identified in the query set QS(Sₑ) for the keyword k;
(Q_{f}ⁱ, Q_{b}ⁱ) represents the query pair i among query pairs (1 . . . n) identified in the query set QS(Sₑ) for the keyword k;
σ represents a query predicate corresponding to the keyword k; and
Score (σ|(Q_{f}, Q_{b})) represents a confidence score computed for the query predicate σ and the query pair (Q_{f}, Q_{b}),
upon determining that a keyword does not represent a categorical keyword and that the keyword does not represent a numeric keyword, associating the keyword in the keyword map with a query predicate applying a textual restriction to at least one textual attribute of the data set;
upon identifying a dictionary keyword in the dictionary matching a keyword, associating the keyword in the keyword map with a query predicate associated with the attribute of the data set; and
normalizing the confidence scores associating respective keywords with query predicates in the keyword map according to the respective confidence score thresholds;
partitioning the query into at least one keyword set, respective keywords of the keyword set matching at least one token of the query and computing an aggregate confidence score comprising the confidence scores of the query predicates associated with the keywords of the keyword set according to the keyword map by, for a query portion comprising at least a first token and a second token:
computing a first token confidence score of a first keyword associated with the first token according to the keyword map;
computing a second token confidence score of a second keyword associated with the second token according to the keyword map;
computing an aggregated token confidence score of a third keyword associated with the first token and the second token according to the keyword map;
if the first token confidence score and the second token confidence score exceed the aggregated token confidence score, partitioning the query into the first keyword associated with the first token and a query portion comprising at least the second token; and
if the aggregated token confidence score exceeds the first token confidence score and the second token confidence score, partitioning the query into the third keyword associated with the first token and the second token;
generating a translated query comprising the query predicates associated with the keywords of a keyword set having a high aggregate confidence score, wherein a keyword of the keyword set comprising a numeric keyword associated with a numeric attribute of the data set is represented in the translated query as a query predicate representing the numeric keyword as a numeric range within the numeric attribute; and
applying the translated query to the data set.
